(19) United States
(12) Patent Application Publication
(10) Pub. No.: US 2026/0327494 A1
(43) Pub. Date: Oct. 22, 2026

(54) METHOD AND SYSTEM FOR CONVERSION OF BIOMASS TO BIOFUEL AND EXTRACTION OF CARBON-CONTAINING PRODUCTS

(71) Applicant: Greenwater LTD, Toronto (CA)

(72) Inventors: Anders MOKVIST, Snelville, GA (US); Ed McKay, Hampton (CA); David Mackie, North Vancouver (CA)

(73) Assignee: Greenwater LTD, Toronto (CA)

(21) Appl. No.: 19/728,231

(22) Filed: Jul. 1, 2026

Related U.S. Application Data
(63) Continuation of application No. 18/903,311, filed on Oct. 1, 2024.
Application No. 18/903,311 is a continuation of application No. 18/503,850, filed on Nov. 7, 2023, now Pat. No. 12,104,120.
Application No. 18/503,850 is a continuation of application No. 17/317,875, filed on May 11, 2021, now Pat. No. 11,807,814.
(60) Provisional application No. 63/022,961, filed on May 11, 2020.

(51) Int. Cl. C10G 1/00; B01D 3/14; C10L 1/08

(52) U.S. Cl. CPC C10G 1/002; B01D 3/14; C10L 1/08; C10G 2300/1011; C10G 2400/04; C10L 2200/0469; C10L 2270/026; C10L 2290/24; C10L 2290/543

(57) ABSTRACT

A method and system for converting biomass to biofuel includes a reaction apparatus having a reaction vessel configured to contain a reaction fluid, an insulated venting tower fluidly coupled thereto, and a mechanical rotating device, which includes a chamber configured to operate within the reaction fluid, the chamber having an interior cavity and including a first section including a first rotatable member and configured to receive biomass feedstock, a second section including a second rotatable member and configured to process biomass feedstock, and a third section including a third rotatable member and configured to treat the processed biomass feedstock. The method and system further include a shaft coupled to the rotatable members and configured to rotate the rotatable members about an axis, and a drive source for driving the shaft about the axis.

### CROSS-REFERENCE TO RELATED APPLICATIONS

The present application is a continuation-in-part of application Ser. No. 18/903,311, filed Oct. 1, 2024, which is a continuation of U.S. application Ser. No. 18/503,850 filed Nov. 7, 2023, which issued on Oct. 1, 2024 as U.S. Pat. No. 12,104,120, which is a continuation of U.S. application Ser. No. 17/317,875 filed on May 11, 2021, which issued on Nov. 7, 2023 as U.S. Pat. No. 11,807,814, which claims the benefit of and priority to U.S. Provisional Application No. 63/022,961 filed on May 11, 2020, the entirety of which are hereby incorporated herein by reference.

### FIELD OF THE INVENTION

The present invention relates to methods and system for conversion of biomass to biofuel, such as liquid biodiesel.

### BACKGROUND OF THE INVENTION

In the production of renewable biofuels, such as diesel, from cellulosic material, most prior commercial systems and processes have been based on pyrolysis with different levels of success. Further, prior commercial systems are also very expensive, time consuming, and require many process steps. In such a pyrolysis process, where the temperature in a reactor needs to reach above 350 degrees Celsius, undesirable byproducts such as dioxins, furans, and coke are produced among the reaction product. After the pyrolysis step, the reaction product then needs to be further converted through gasification or other additional processing to produce a desirable, useable final product. As such, a majority of the products produced in these prior commercial processes are not able to be converted and end up being burned for process heat. To this end, only 20% or less of the biomass calorific value is converted to biofuel.

While progress has been made in efforts to convert cellulosic feed stock to ethanol through a dilute acid process, they have been unsuccessful in meeting viable commercial targets. When converting cellulose to sugar, the process requirements of high temperature and pressure, in combination with low pH, makes the required process equipment material selection limited and expensive. Furthermore, the product from this process is a tarlike sugar and lignin mixture, which makes the sugar extraction a challenge. Still further, ethanol as a fuel source has drawbacks including: a lower heat value production (29 MJ/Kg for ethanol compared to 43 MJ/Kg for gasoline and diesel), and, since ethanol is an alcohol, it is subject to water absorption.

Accordingly, there remains a need for a process and system for converting biomass to biofuel that can use cellulosic biomass as feed to produce an alternate biofuel to ethanol. Such a process and system for the conversion of biomass to liquid biofuel would preferably be capable of increasing yield, reducing energy requirements, reducing costs, and reducing the footprint of the system. This need and other needs are satisfied by the various aspects of the present disclosure.

### SUMMARY OF THE INVENTION

In accordance with the purposes of the invention, as embodied and broadly described herein, the invention, in one aspect, relates to a method and system for conversion of biomass to biofuel. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one illustrative aspect, the invention relates to a method and system for converting biomass to biofuel, such as biodiesel. To achieve an improved conversion of biomass to liquid biofuel, the disclosed method and system can advantageously produce biomass exhibiting more uniform and smaller particle size. In further aspects, the disclosed method and system can expose processed biomass to mixing and kneading with the process fluid effective to promote the required interaction of the biomass and the process fluid.

In another illustrative aspect, the invention relates to an integrated reaction apparatus comprising: a) a process or reaction tank having an inner surface defining an interior space and configured to hold a reaction or process fluid; and b) at least one mechanical rotating device comprising: a submergible chamber configured to operate within process fluid contained within the reaction tank, the submergible chamber having an inner surface defining an interior space and comprising a plurality of zones including: at least one zone or section configured to receive and feed biomass feedstock to an adjacent zone; at least one zone or section configured to process or size reduce biomass feedstock received from an adjacent zone; and at least one zone or section configured to treat or need the size reduced biomass feedstock with process fluid and catalyst under conditions effective to convert at least a portion of the processed biomass feedstock to at least one reaction product.

In another illustrative aspect, the invention relates to a system for converting biomass to biofuel, the system comprising a reaction apparatus comprising: a reaction tank having an inner surface defining an interior space and configured to hold a process fluid; at least one mechanical rotating device comprising: a submergible chamber configured to operate within reaction fluid contained within the reaction tank, the submergible chamber having an inner surface defining an interior space and comprising a plurality of zones including: a zone (or section) including a rotatable member and configured to process biomass feedstock; and a zone (or section) including a rotatable member and configured to treat the processed biomass feedstock effective to convert at least a portion of the processed biomass feedstock to at least one reaction product; a shaft in operable communication with each of the rotatable members for rotating said rotatable members about an axis; and a drive source for driving the shaft about said axis. In some aspects, the chamber may comprise an additional zone with an additional rotatable member for receiving feedstock.

In another illustrative aspect, the invention relates to a system for converting biomass to biofuel, the system comprising: a reaction apparatus comprising: a) a reaction tank having an inner surface defining an interior space and configured to hold a reaction or process fluid; b) at least one mechanical rotating device comprising: a submergible chamber configured to operate within reaction fluid contained within the reaction tank, the submergible chamber having an inner surface defining an interior space and comprising a plurality of zones including: a first zone (or section) including a first rotatable member and configured to receive biomass feedstock; a second zone (or section) including a second rotatable member and configured to process biomass feedstock from the first feeding zone; and a third reaction zone (or section) including a third rotatable member and configured to treat the processed biomass feedstock effective to convert at least a portion of the processed biomass feedstock to at least one reaction product; a shaft in operable communication with each of the first, second, and third rotatable members for rotating said rotatable members about an axis; and a drive source for driving the shaft about said axis. In further aspects, the system may further comprise a biomass feed module, a distillation module, and/or a biofuel polishing module.

In another illustrative aspect, the invention relates to a mechanical rotating device configured to operatively couple with a reaction tank, the mechanical rotating device comprising a submergible chamber configured to operate within process fluid contained within the reaction tank, the submergible chamber having an inner surface defining an interior space and comprising a plurality of zones including a zone (or section) including a rotatable member and configured to process biomass feedstock; and a reaction zone (or section) including a rotatable member and configured to treat the processed biomass feedstock effective to convert at least a portion of the processed biomass feedstock to at least one reaction product; a shaft in operable communication with each of the rotatable members for rotating said rotatable members about an axis. In some aspects, the shaft may be configured to be driven about said axis using a drive source. In other aspects, multiple mechanical rotating devices may be operated in a single reaction tank or vessel. In further aspects, the disclosed device can be used for various applications in addition to conversion of biomass to biofuel, such as, and without limitation, extraction of lignin, oils, and other components from different biomass types. In some aspects, the reaction or process fluid may be carrier oil. In other aspects, the reaction or process fluid may be a solvent. Without wishing to be bound by a particular theory, embodiment of the disclosed device and systems include a reaction zone with an inventive conical design and configuration that can allow for closer and sustained contact between the process fluid and the biomass.

In further aspects, the invention also relates to additional methods for using the disclosed apparatuses and systems to convert biomass to biofuels and extract carbon containing products.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are illustrative and explanatory only and are not restrictive of the invention, as claimed. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate several aspects of the invention and together with the description, serve to explain the principles of the invention. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIGS. 1A-1B show depiction of a system in an operating environment in accordance with an illustrative embodiment of the present disclosure.

FIGS. 2A-2B show depictions of an integrated reaction apparatus from a system for producing biofuel in accordance with an illustrative embodiment of the present disclosure.

FIGS. 3A-3C show various views of a feed screw from a mechanical rotating device in accordance with an embodiment of the present invention.

FIGS. 4A-4C show various views of a feed screw from a mechanical rotating device in accordance with another embodiment of the present invention.

FIGS. 5A-5C show various views of a cylindrical rotor from a mechanical rotating device in accordance with an embodiment of the present invention.

FIGS. 6A-6D show various views of a cylindrical rotor from a mechanical rotating device in accordance with an embodiment of the present invention.

FIGS. 7A-7D show various views of a cylindrical stator from a mechanical rotating device in accordance with another embodiment of the present invention.

FIGS. 8A-8E show various views of a cylindrical stator from a mechanical rotating device in accordance with an embodiment of the present invention.

FIGS. 9A-9D show various views of a conical rotor from a mechanical rotating device in accordance with an embodiment of the present invention.

FIGS. 10A-10D show various views of a conical stator from a mechanical rotating device in accordance with an embodiment of the present invention.

FIGS. 11A-11D show various views of a conical stator from a mechanical rotating device in accordance with another embodiment of the present invention.

FIG. 12 shows a diagram of system configuration in accordance with an illustrative embodiment of the present disclosure.

FIG. 13 shows a diagram of a prior biomass conversion system.

FIG. 14 is a flow chart of a method for producing biofuel from biomass using a disclosed system in accordance with an illustrative embodiment of the present disclosure.

FIG. 15 shows depiction of an alternative system in an operating environment, in accordance with an illustrative embodiment of the present disclosure.

FIG. 16 shows depiction of a feedstock preparation system, in accordance with an illustrative embodiment of the present disclosure.

FIG. 17 is a flow chart of a method for producing biofuel from feedstock biomass using the system of FIG. 15.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “a tank” includes two or more tanks.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the materials, components, parts, and/or elements to be used to manufacture the disclosed devices and systems of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. System and Device Overview

As briefly described above, the present disclosure provides, in various aspects, a method, device and system for converting biomass to biofuel, such as biodiesel. In one aspect, to achieve an improved conversion of biomass to liquid biofuel, the disclosed method and system can advantageously produce biomass exhibiting more uniform and smaller particle size. In further aspects, the disclosed method and system employing a reaction zone having an inventive conical design and configuration can expose processed biomass to mixing and kneading with the process fluid effective to promote the required interaction of the biomass and the process fluid.

This overview is provided to introduce a selection of concepts in a simplified form that are further described below. This overview is not intended to identify key features or essential features of the claimed subject matter. Nor is this overview intended to be used to limit the claimed subject matter's scope. For example, the disclosed method and system may have several other use cases or applications, such as, the use of a solvent to separate lignin and cellulose, and other components of biomass.

In various aspects, the present invention provides a system that can include an integrated reactor apparatus that can eliminate the need for separate process vessels, such as separate mixing vessel and/or secondary distillation vessel. In further aspects, the integrated reactor apparatus, which can utilize a submergible mechanical rotating device, can be configured to produced processed biomass exhibiting more uniform and smaller particle sizes. In still further aspects, the integrated reactor apparatus can be configured to expose the processed biomass to process fluid effective to enhance interaction between the processed biomass and process fluid.

In still further aspects, the present invention provides a system comprising a reaction apparatus comprising: a reaction tank having an inner surface defining an interior space and configured to hold a process fluid; at least one mechanical rotating device comprising: a submergible chamber configured to operate within reaction fluid contained within the reaction tank, the submergible chamber having an inner surface defining an interior space and comprising a plurality of zones including: a zone (or section) including a rotatable member and configured to process biomass feedstock; and a zone (or section) including a rotatable member and configured to treat the processed biomass feedstock effective to convert at least a portion of the processed biomass feedstock to at least one reaction product; a shaft in operable communication with each of the rotatable members for rotating said rotatable members about an axis; and a drive source for driving the shaft about said axis. In some aspects, the chamber may comprise an additional zone with an additional rotatable member for receiving feedstock.

In yet further aspects, the present invention provides a mechanical rotating device configured to operatively couple with a reaction tank, the mechanical rotating device comprising a submergible chamber configured to operate within process fluid contained within the reaction tank, the submergible chamber having an inner surface defining an interior space and comprising a plurality of zones including a zone (or section) including a rotatable member and configured to process biomass feedstock; and a reaction zone (or section) including a rotatable member and configured to treat the processed biomass feedstock effective to convert at least a portion of the processed biomass feedstock to at least one reaction product; a shaft in operable communication with each of the rotatable members for rotating said rotatable members about an axis. In some aspects, the shaft may be configured to be driven about said axis using a drive source. In other aspects, multiple mechanical rotating devices may be operated in a single reaction tank or vessel. The disclosed device can be used for various applications in addition to conversion of biomass to biofuel, such as, and without limitation, extraction of lignin, oils, and other components from different biomass types. As will be further described herein, embodiments of the disclosed devices and systems include a reaction zone with an inventive conical design and configuration that can allow for closer and sustained contact between the process fluid and the biomass.

Tight temperature control, among other process conditions, in a process tank or vessel is vital to produce the desired reaction products in the highest yields. In one aspect, a system and method in accordance with the present invention may be configured to avoid the pyrolysis temperature phase. To this end, a 10 °C variation can have a dramatic effect on the results and outcome of the process, such as production of unwanted reaction products and/or lower yields. By way of further example, prior systems often require pumping oil between different process tanks having large temperature ranges, making temperature control problematic while consuming substantial energy. In addition, these prior systems commonly employ a turbine, installed and operated in a loop, from and back to main process tank. This configuration requires additional control, piping system, pump and valves. Furthermore, turbines are installed in a loop outside the process vessels where the temperature of return oil is dependent of flow and energy applied, which is an additional temperature control challenge and source of energy loss.

In one aspect, the present disclosure provides an integrated reaction apparatus comprising: a) a process or reaction tank having an inner surface defining an interior space and configured to hold a reaction or process fluid; and b) at least one mechanical rotating device comprising: a submergible chamber configured to operate within reaction fluid contained within the reaction tank, the submergible chamber having an inner surface defining an interior space and comprising a plurality of zones including: at least one zone or section configured to receive and feed biomass feedstock to an adjacent zone; at least one zone or section configured to process or size reduce biomass feedstock received from an adjacent zone; and at least one zone or section configured to treat or need the size reduced biomass feedstock with process fluid and catalyst under conditions effective to convert at least a portion of the processed biomass feedstock to at least one reaction product. The introduction of the new mechanical rotating device is designed to be submerged in the process tank while being able to feed, size reduce, and knead to achieve improved uniformity of biomass during processing and conversion. The new mechanical rotating device was further designed to treat the biomass in a conical kneading and mixing zone, as detailed herein.

In another aspect, the present disclosure provides a system for converting biomass to biofuel, the system comprising at least one reaction apparatus. In further aspects, a reaction apparatus may comprise: a) a reaction tank having an inner surface defining an interior space and configured to hold a reaction or process fluid; b) at least one mechanical rotating device comprising: a submergible chamber configured to operate within reaction fluid contained within the reaction tank, the submergible chamber having an inner surface defining an interior space and comprising a plurality of zones including: a first zone (or section) including a first rotatable member and configured to receive biomass feedstock; a second zone (or section) including a second rotatable member and configured to process biomass feedstock from the first feeding zone; and a third reaction zone (or section) including a third rotatable member and configured to treat the processed biomass feedstock effective to convert at least a portion of the processed biomass feedstock to at least one reaction product; a shaft in operable communication with each of the first, second, and third rotatable members for rotating said rotatable members about an axis; and a drive source for driving the shaft about said axis. In further aspects, the system may further comprise a biomass feed module, a distillation module, and/or a biofuel polishing module.

In further aspects, the system or apparatus may comprise a plurality of mechanical rotating devices. In still further aspects, the plurality of zones may comprise at least one of: a feeding zone, a processing zone and/or reaction zone, or combinations thereof. In yet further aspects, a first zone may comprise a first feeding zone (or section) including a first rotatable member and configured to receive biomass feedstock. In even further aspects, a second zone may comprise a first processing zone (or section) including a second rotatable member and configured to process or size reduce biomass feedstock from the first feeding zone. In still further aspects, a third zone may comprise a first reaction zone (or section) including a third rotatable member and configured to treat or knead the processed biomass feedstock under conditions effective to convert at least a portion of the processed biomass feedstock to at least one reaction product, for example, in the presence of process liquid, catalyst, and/or lime. To this end, a reaction zone may comprise or otherwise contain catalyst and lime. In an illustrative embodiment, the catalyst is zeolite.

In further aspects, at least one zone may comprise a feed section configured to receive and feed biomass feedstock to an adjacent zone. In still further aspects, at least one zone may comprise a size reduction section configured to size reduce biomass feedstock received from another zone. In even further aspects, at least one zone may comprise a kneading section configured to knead the processed biomass feedstock with catalyst and reaction fluid under conditions effective to convert at least a portion of the processed biomass feedstock to at least one reaction product.

In various aspects, the plurality of zones may be in a stacked configuration. To this end, a first zone may be in fluid communication with the second zone, and/or a second zone may be in fluid communication with the third zone. For example, a first feeding zone may be in fluid communication with a first processing zone, and/or a first processing zone may be in fluid communication with a first reaction zone, and so on.

In further aspects, each zone or section may comprise at least one rotatable member. In still further aspects, a rotatable member may comprise a feed screw, rotor, or the like. In yet further aspects, a rotatable member may comprise a surface profile defined by one or more blades, teeth, or fins disposed on an outer surface. In some aspects, a blade may comprise a spiral blade. In further aspects, a first rotatable member may comprise a feed screw configured to move biomass feedstock from a feeding zone into a processing zone, such as for size reduction. A second rotatable member may comprise a cylindrical rotor configured to process the biomass feedstock, for example, by size reducing the biomass. In still further aspects, a third rotatable member may comprise a conical rotor configured to facilitate conversion of the processed biomass feedstock into at least one reaction product, for example, by kneading the size reduced biomass with process fluid and catalyst. To this end, conditions may start a catalytic reaction which extracts the oxygen content from the biomass feed material, in form of CO2, water and the formation of oil without any oxygen content.

In further aspects, at least one zone or section may comprise a processing section or processing zone having a rotatable member configured to size reduce biomass feed, for example, prior to introduction of the biomass into an adjacent zone or section.

In still further aspects, at least one zone or section may comprise a reaction section or reaction zone having a conical design and configuration, such as, for example, employing a conical rotatable member configured to increase retention time of biomass within the zone. The inventive conical design and configuration employed in various zones and section of the disclosed devices and systems can function to extend the retention (e.g., kneading) time in the device chamber by separating of the biomass feed material by density. For example, in a cylindrical section, as the rotation speed of a shaft and rotors are increased, retention time is shortened. However, in the conical section, the biomass material density separation is higher and retention time is dependent on the production or conversion rate.

In further aspects, the apparatus or system may comprise conditions effective to convert at least a portion of the processed biomass feedstock to one or more desired reaction products. In still further aspects, conditions effective may comprise: atmospheric pressure, alkali conditions, process and/or temperature range: 250-350 °C, or combinations thereof. In some specific embodiments, conditions effective to convert at least a portion of the processed biomass feedstock may comprise: a process pressure of about 17 MPa (2465 psig), a biomass conversion time of about 30 minutes, and at a temperature of about 280 °Celsius. (536 °F). In yet further aspects, conditions effective to convert at least a portion of the processed biomass feedstock may comprise a conical configuration or construction in a reaction zone of the chamber for increasing retention time of biomass within said zone.

In further aspects, biomass may comprise any cellulosic organic material. In even further aspects, biomass can also include: commercial or recycled material including plastic, paper, paper pulp, cardboard, sawdust, timber residue, wood shavings and cloth; agricultural waste such as sugar cane, shells, coffee grounds; and agricultural feed products. Biomass is typically comprised of a wide array of compounds classified within the categories of cellulose, hemicelluloses, lignin, starches, and lipids. In still further aspects, reaction or end product of the present invention may comprise at least one of biofuel, water, char, ash, and/or carbon dioxide, and combinations thereof. The disclosed method and system may break down the long carbon molecules by removal of oxygen into water and carbon dioxide.

In still further aspects, the biofuel may comprise renewable liquid fuel. The renewable liquid fuel may be in the diesel boiling range. In some aspects, the renewable liquid fuel may comprise diesel fuel.

In further aspects, the apparatus and system may include a drive source for driving the shaft, and any component in operable or mechanical communication thereof. In still further aspects, the drive source may comprise a motor, such as an electric motor or gas motor, or the like. In some aspects, each of the rotatable members may be driven by the same drive source. In still further aspects, the apparatus and system may comprise a power source. The power source may comprise a generator, for example, a diesel generator. In some aspects, the power source may comprise a diesel generator configured to operate using biofuel produced by the system. To this end, the disclosed system can be configured to generate its own electricity and power requirements. Further, the exhaust stream from the generator can be used to heat the process fluid and/or biomass drying. For example, if 100 l/hour of the produced biofuel is used, 436 kWh of electricity may be generated at a 43% generator conversion rate (83 kg/h=3652000 KJ). The exhaust stream from the generator diesel engine, having temperature of 550 °C, may be temperature reduced to about 325 °C (41% or 208 kWh) to heat the process oil, and the remaining heat may be used for biomass drying. Still further, any excess electricity may be put onto the electric grid.

In further aspects, the apparatus and system may include at least one of: a separation module, a distillation module, a biomass feed module configured to dispense biomass feedstock into the system, and/or a biofuel polishing module. A separation module may comprise one or more of: a separation tower, condenser, and/or measuring pipe, or combinations thereof. A distillation module may comprise one or more of: a distillation tower, condenser, and/or measuring pipe, or combinations thereof. A biomass feed module may comprise a biomass feed bin, biomass feed screw or conveyor, and/or biomass heater, or combinations thereof.

In further aspects, each of the rotatable members of the mechanical rotating device are configured to pivotably rotate about an axis. Each of the zones and rotatable members may comprise specific component characteristics and configuration, such as, for example, size and dimensions, that can be configured to adjust for intended function, and other factors to achieve optimal process parameters, reaction products and/or product yield. In further aspects, features of the system and components may be configured or utilized to set and/or control the characteristics. For example, at least one of the following may be configured: the type of material used for the components; the member dimensions (e.g., height, width, thickness, shape, fin or surface profile, etc.); location of the member; and the like.

In further aspects, while certain components of the disclosed system described herein can be permanently mounted in or on a component, this is not a requirement. For example, the rotatable member can be configured to be removably attached to the shaft, e.g., to allow interchange and/or replacement rotatable members in each zone. Such configurations allow workers, or others to select desired properties or levels in a zone, e.g., for customization purposes, for process preferences, to match desired use conditions, biomass physical characteristics, or to repair or replace defective or damaged components, etc. Further, since the mechanical rotating device can be configured to be removably installed in existing process vessels, the present disclosure also provides a retrofittable integrated reactor comprising the components of the integrated reactor apparatus, such as the mechanical rotating device.

In various aspects, the components of the disclosed system and components can be detachably attached. In further aspects, the components can be connected by a connecting means. In still further aspects, the connecting means can comprise a fitting, insert, adhesive, brazing, soldering, welding, spot weld, screw with nut, rivet, threading, friction fit, snap-fit, twist-lock, or interlocking mechanism or a combination thereof. In yet further aspects, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the system can comprise an engagement means for coupling and holding components together. In a further aspect, the engagement means can be a screwing mechanism, a click-lock mechanism, or friction mechanism, or the like. In still further aspects, the system components can be integrally or mechanically attached to other components. In a yet further aspect, the disclosed components can be connected, attached, or mounted using a connecting means, the connecting means comprising a fitting, insert, adhesive, brazing, soldering, welding, spot weld, screw with nut, rivet, fitting, insert, threading, friction fit, or snap-fit or a combination thereof.

In various aspects, advantages of the disclosed apparatuses and systems employing the submerged mechanical rotating device include at least one of: Lower total process energy requirements; Expected higher product yield; Lower heat losses; Improved process temperature control; Simplified system and operation; No requirement for pipes, valves between process tanks; Smaller system footprint; Lower equipment and installation cost; Agitation of the process tank; and Fewer control loops.

In further aspects, the disclosed methods and systems provide advantages over pyrolysis-based methods and systems that can include one or more of the following: Atmospheric pressure and Alkali conditions; High conversion of the biomass heat value to diesel; Fewer process steps; Lower cost compared to the pyrolysis-based processes; Compact installation, small footprint; Production of biofuel with a high cetane value as a finished product which can be used as transport fuel; process outputs of biodiesel, distilled water, ash and CO2; Biodiesel produced from the biomass (cellulosic feed) is similar to petroleum diesel, but exhibits higher cetane numbers, lower cold pour point and no aromatics; biofuel produced can be used in any proportion in today's infrastructure from pipelines and storage to gas pumps and automobiles/engines; biofuel produced can be blended with petroleum diesel in any proportion; biofuel produced can have excellent stability and is not oxygenated.

### C. System Configuration

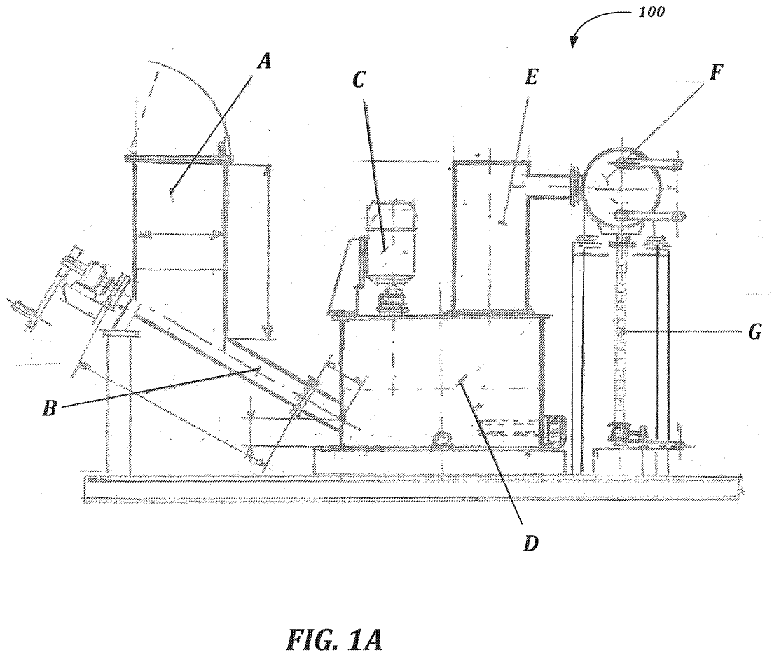

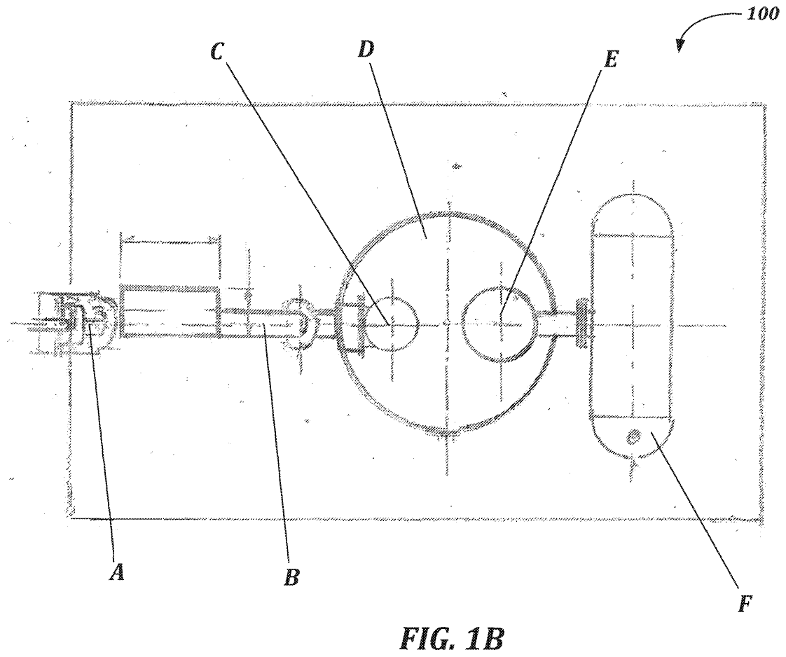

According to various aspects of the invention, the methods, apparatuses, devices and systems of the present disclosure can comprise multiple configurations. FIGS. 1-9 illustrate non-limiting examples of embodiments of operating environments, mechanisms, and components for the disclosed devices and systems. Although the operating environments, mechanisms, and components are disclosed with specific functionality, it should be understood that functionality may be shared between mechanisms and/or components, with some functions split between mechanisms and/or components, while other functions duplicated by the mechanisms and/or components. Furthermore, the name of the mechanisms and/or components should not be construed as limiting upon the functionality of the mechanisms and/or components. Moreover, each stage in a method or claim language can be considered independently without the context of the other stages. Each stage may contain language defined in other portions of this specifications. Each stage disclosed for one mechanism and/or component may be mixed with the operational stages of another mechanism and/or component. Each stage can be claimed on its own and/or interchangeably with other stages of other mechanisms and/or components.

FIGS. 1A-1B show an illustrative embodiment of a system 100 for converting biomass to biofuel in accordance with the present invention. System 100 includes biomass feed module including biomass feed bin (A) and biomass feed screw (B); reaction apparatus including: mechanical rotating device (C) and reaction tank (D); and separation module including: separation tower (E), condenser (F) of water and liquid biofuel, and measuring pipe (G) for condensate from condenser.

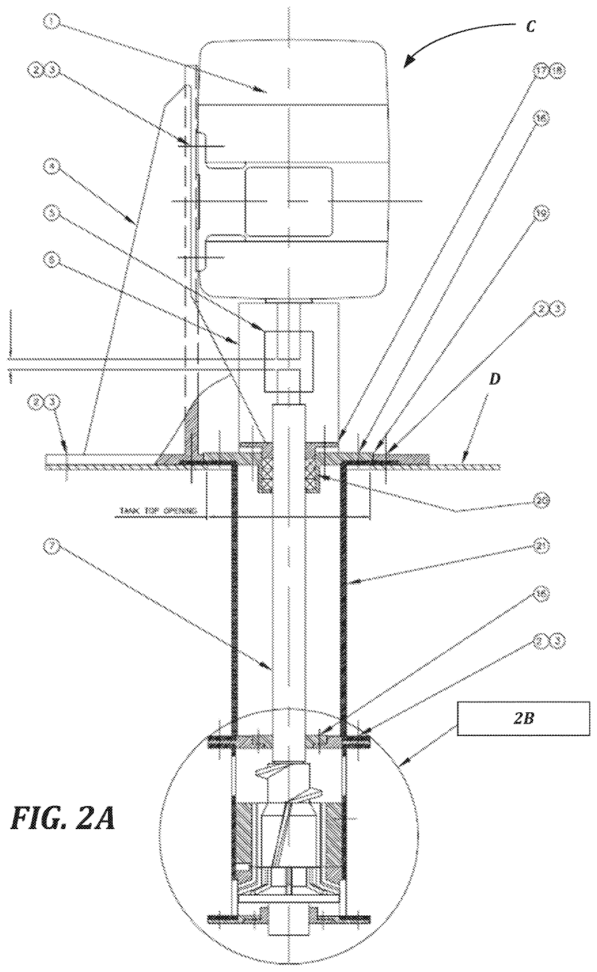

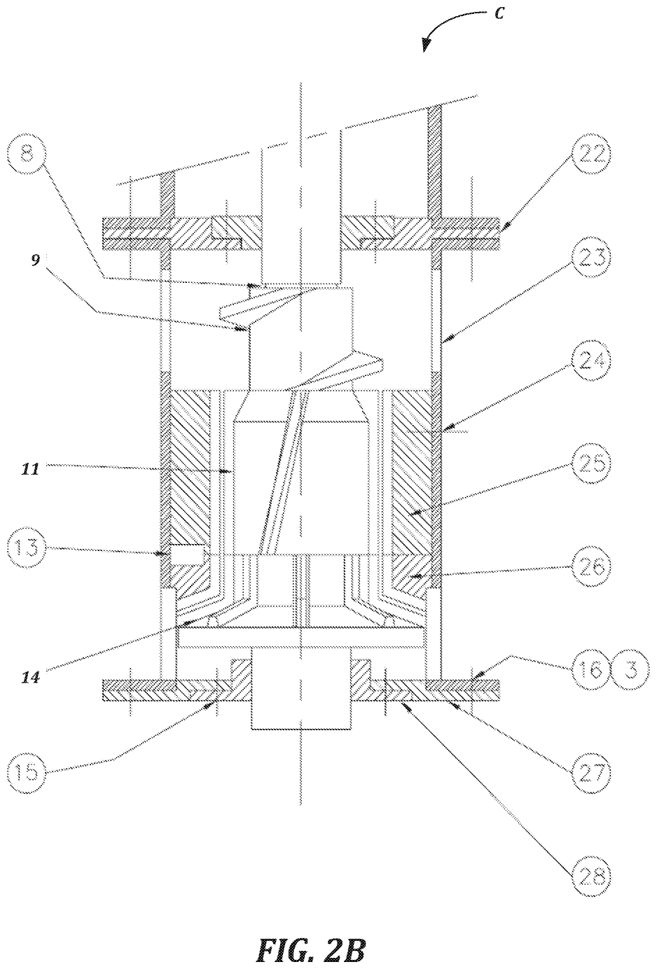

FIGS. 2A-11D depicts various views and components of mechanical rotating device (C) for use in the disclosed reactor apparatus and system 100 in accordance with an illustrative embodiment of the present invention. FIGS. 2A-2B provides side section views of mechanical rotating device (C) including lower housing (23) which defines a submergible chamber configured to operate within reaction fluid contained within the reaction tank (D), the submergible chamber having an inner surface defining an interior space and comprising a plurality of chamber zones including first feed zone with first rotatable feed screw member (9) and configured to receive biomass feedstock; second processing zone with rotatable cylindrical rotor (11) and cylindrical stator (25), which are configured to process biomass feedstock from first feeding zone; third reaction zone with rotatable conical rotor (14) and conical stator (23), which is configured to treat the processed biomass feedstock by kneading it with process oil and catalyst under conditions effective to convert at least a portion of the processed biomass feedstock to at least one reaction product; shaft (7) traveling through spacer housing (21) and in operable communication with each of the first, second, and third zones for rotating rotatable members about an axis; and electric motor (1) for driving the shaft about said axis. As shown, third zone or section comprises a has an inventive conical design and configuration, employing a conical rotatable member configured to increase retention time of biomass within the zone.

This inventive conical design and configuration can function to extend the retention (e.g., kneading) time in the device chamber by separating of the biomass feed material by density. For example, in a cylindrical section, such as the preceding second zone, as the rotation speed of a shaft and rotors are increased, retention time is shortened. However, in the conical third section, the biomass material density separation is higher and retention time is dependent on the production or conversion rate. Alternative conical arrangements and configurations may be employed for increasing retention time of the biomass in the specific zone, such as members that may be fixed to the chamber housing.

The submergible chamber interior space may be sealed at the top by middle cover (22) and at the bottom using lower housing cover (27), and may include various inlet and outlet ports used during biomass feedstock processing. In various embodiments, the lower portion of mechanical rotating device (C) can be configured to be submerged within reaction tank (D) containing reaction or process fluid for reacting with the biomass feedstock. The reaction fluid can comprise process oil. Reaction tank (D) may include at least one fluid inlet port and fluid outlet port. However, in some embodiments fluid intake and removal may occur through a shared port. In other embodiments, there may be a plurality of ports. Any number of additional ports may also be provided, each of which may be used to insert or attach features for viewing the interior of the cartridge or for the measurement of parameters such as, for example, temperature, pressure, or fluid composition. In an illustrative embodiment, process fluid and biomass may enter through four inlet ports at the top of the chamber housing. In some aspects, inlet ports may be located in the area around the feeding or first section of the mixer/reaction chamber. During operation, the biomass and process fluid are forced downwards through the various zones, by rotating feed section, the cylindrical the conical section, and internal rotor parts. Discharge from the mixer chamber may be through four discharge ports at the lower part of the housing area.

In an example embodiment, components of mechanical rotating device (C) shown in the figures may include one or more of the following:
ELECTRIC MOTOR (1);
BOLT (2);
NUT (3);
10202 MOTOR SUPPORT (4),
COUPLING (5), Double Disc;
COUPLING GUARD (6);
SHAFT (7);
SNAP RING, EXTERNAL (8);
FEED SCREW (9);
CYLINDRICAL ROTOR (11);
KEY, ONE END ROUNDED (13);
CONICAL ROTOR (14);
BOLT (15);
BOLT (16);
PACKING GLAND (17);
BOLT (18);
PACKING BOX (19);
PACKING (20);
SPACER HOUSING (21);
MIDDLE COVER (22);
UNIT HOUSING (23);
BOLT (24);
CYLINDRICAL STATOR (25);
CONICAL STATOR (26);
10313 LOWER HOUSING COVER (27);
10314 LOWER BUSHING (28).

In various embodiments, feed screw and/or rotors may comprise a key, such as key with both or one end rounded, such as KEY, ONE END ROUNDED (13).

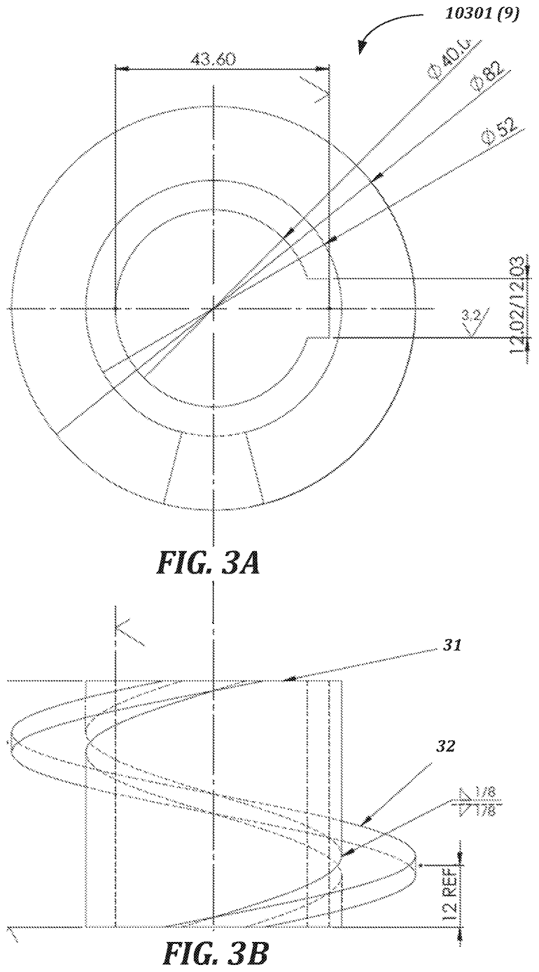

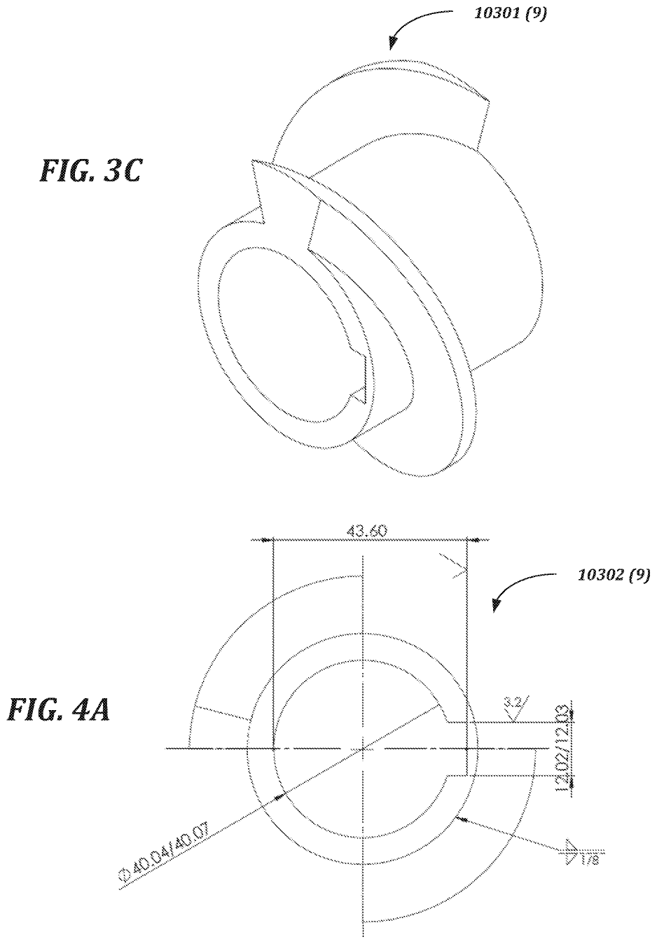

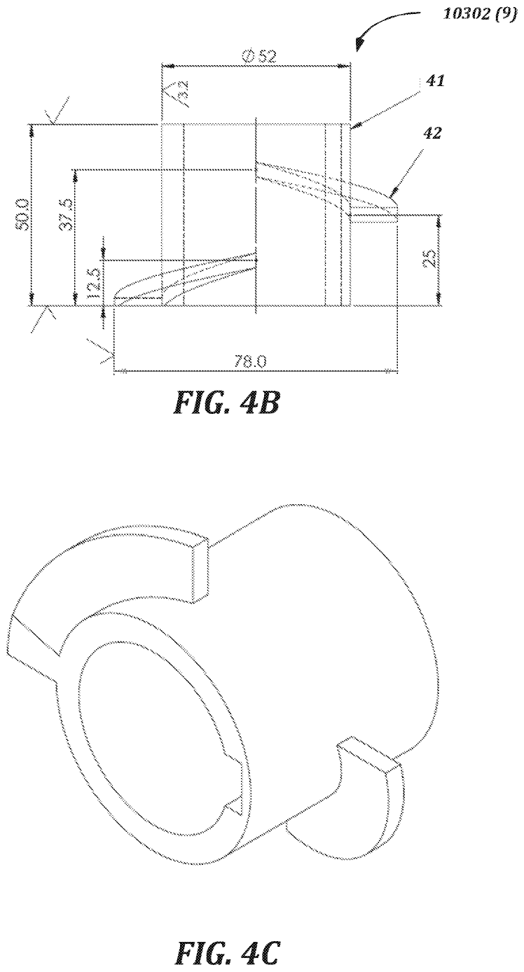

FIGS. 3A-3C shows various view of FEED SCREW 10301, Alternative 1 (9) from mechanical rotating device (C) in accordance with an embodiment of the present invention. FIG. 3A shows a top view, FIG. 3B shows a front view depicting bar element 31 and plate element 32, and FIG. 3C show an isometric view. FIGS. 4A-4C shows various view of FEED SCREW 10302, Alternative 2 (9) from mechanical rotating device (C) in accordance with another embodiment of the present invention. FIG. 4A shows a top view, FIG. 4B shows a front view depicting bar element 41 and plate element 42, and FIG. 4C show an isometric view.

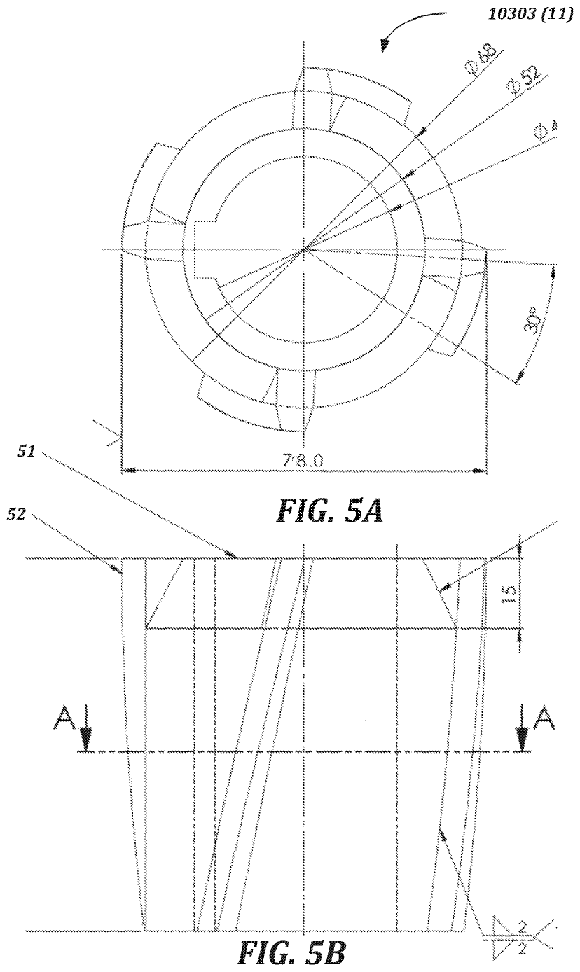

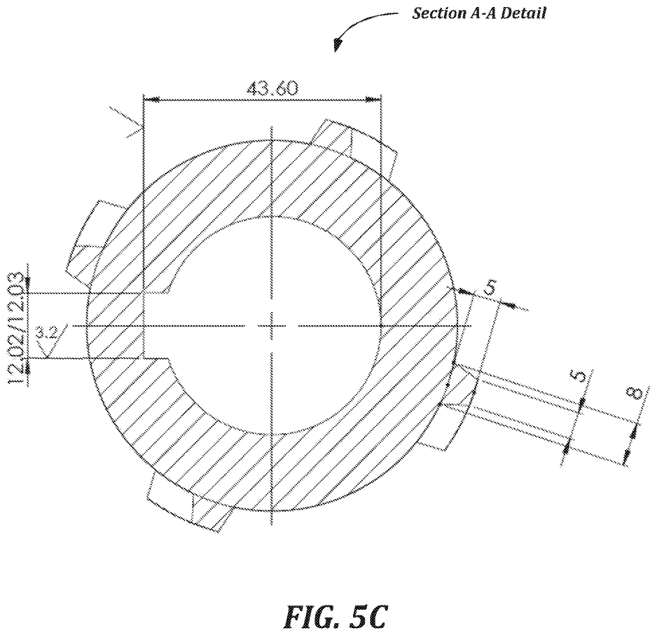

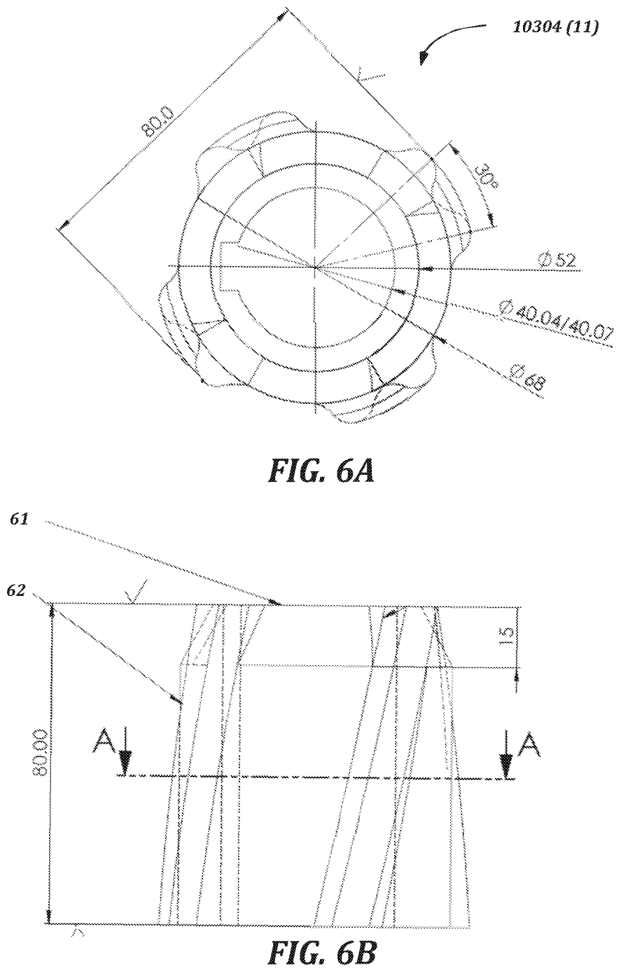

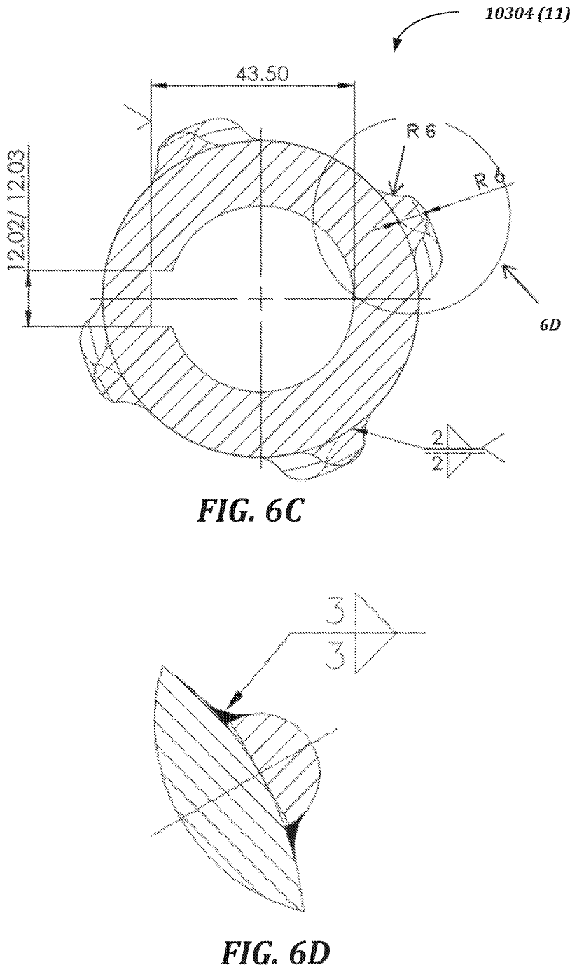

FIGS. 5A-5C shows various view of CYLINDRICAL ROTOR, A01 10303 (11) from mechanical rotating device (C) in accordance with an embodiment of the present invention. FIG. 5A shows a top view thereof, FIG. 5B shows a front view depicting first bar element 51 and second bar element 52 on surface profile, and FIG. 5C show a section view of A-A from FIG. 5B. FIGS. 6A-6D shows various view of CYLINDRICAL ROTOR A02 10304 (11) from mechanical rotating device (C) in accordance with another embodiment of the present invention. FIG. 6A shows a top view thereof, FIG. 6B shows a front view depicting first bar element 61 and multiple second bar elements 62 on surface profile, FIG. 6C show a section view of A-A from FIG. 6B, and FIG. 6D show a detail view 6D from FIG. 6C.

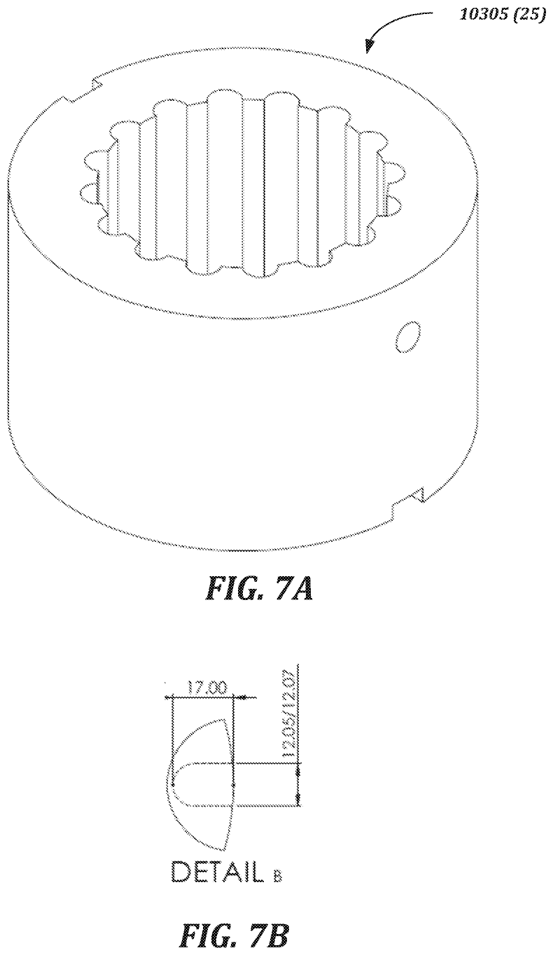

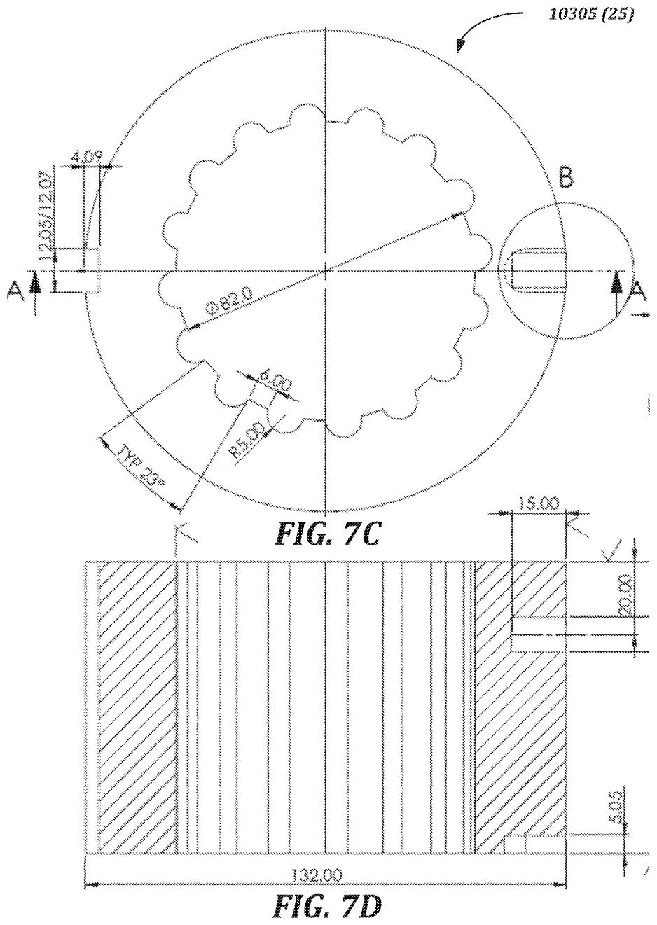

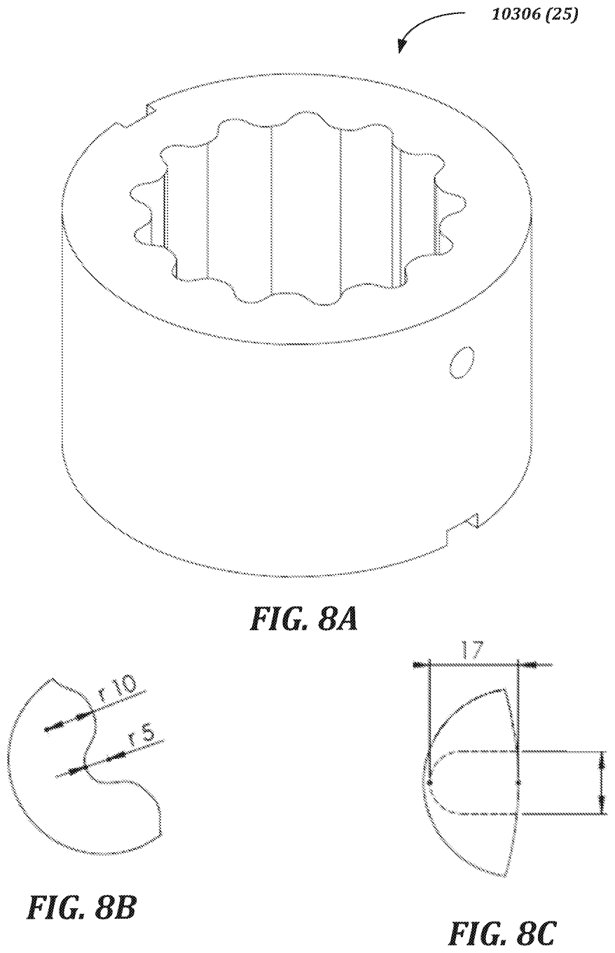

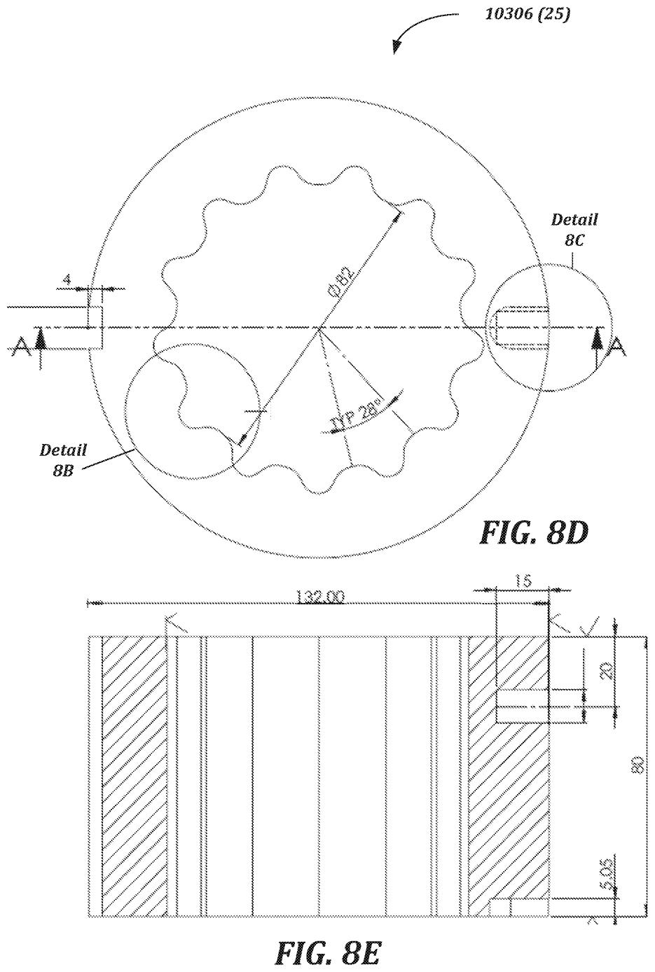

FIGS. 7A-7D shows various view of CYLINDRICAL STATOR A01 10305 (25) from mechanical rotating device (C) in accordance with an embodiment of the present invention. FIG. 7A shows an isomeric view thereof, FIG. 7B shows detail view from FIG. 7C, which shows a top view, and FIG. 7D show a section view of A-A from FIG. 7C. FIGS. 8A-8E shows various view of CYLINDRICAL STATOR B01 10306 (25) from mechanical rotating device (C) in accordance with another embodiment of the present invention. FIG. 8A shows an isomeric view thereof, FIGS. 8B and 8C shows detail view from FIG. 8D, which shows a top view, and FIG. 8E show a section view of A-A from FIG. 7C.

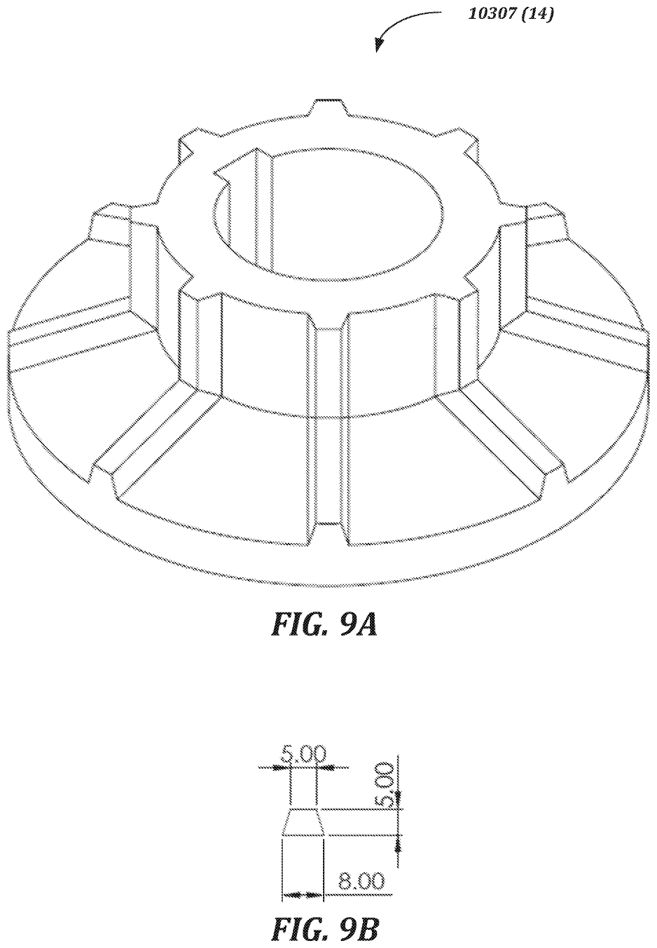

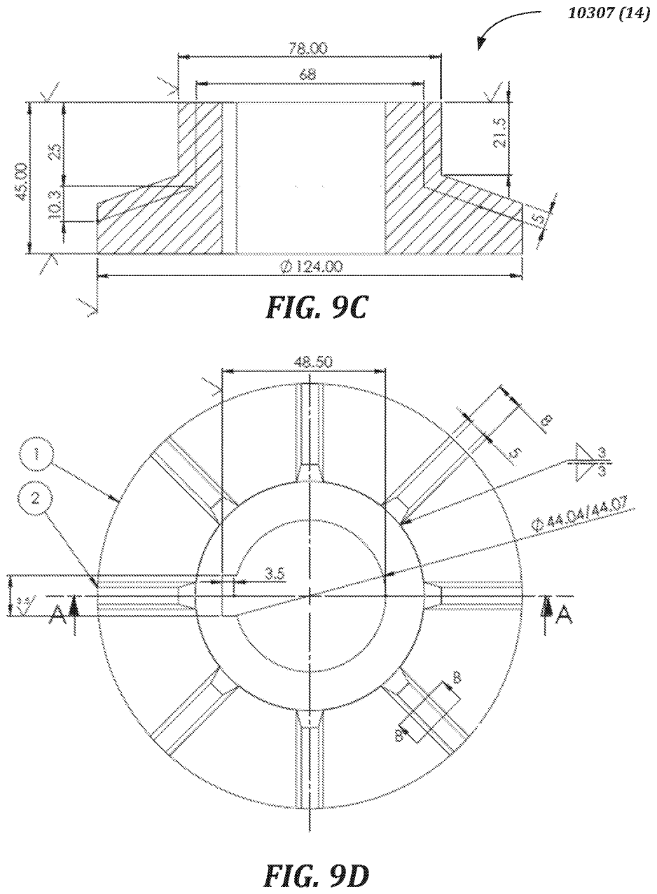

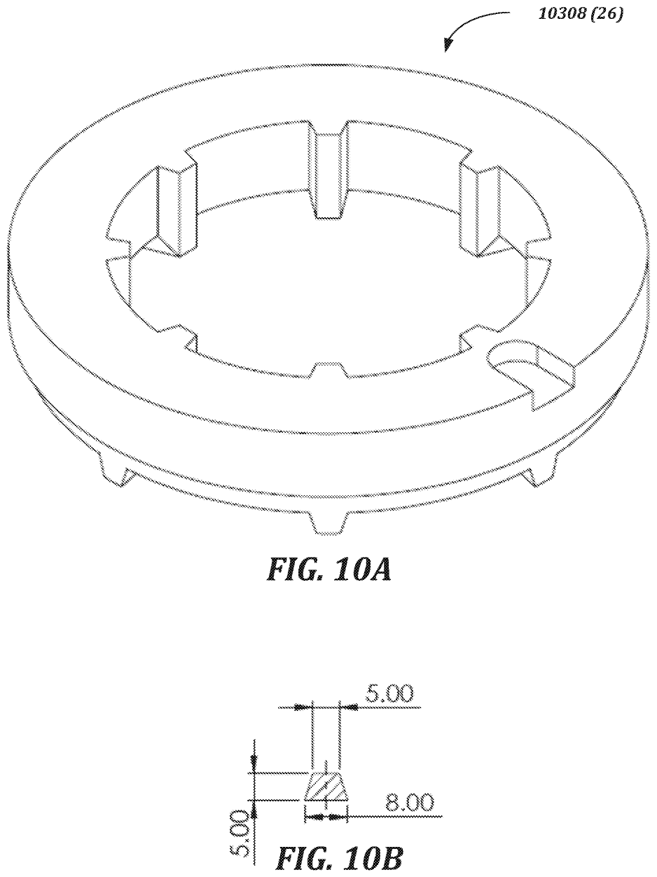

FIGS. 9A-9D shows various view of CONICAL ROTOR 10307 (14) from mechanical rotating device (C) in accordance with an embodiment of the present invention. FIG. 9A shows an isomeric view thereof, FIG. 9B shows detail view from FIG. 9D, which shows a top view depicting plate portion 91 and eight bar elements 92 on the surface, and FIG. 9C show a section view of A-A from FIG. 9D.

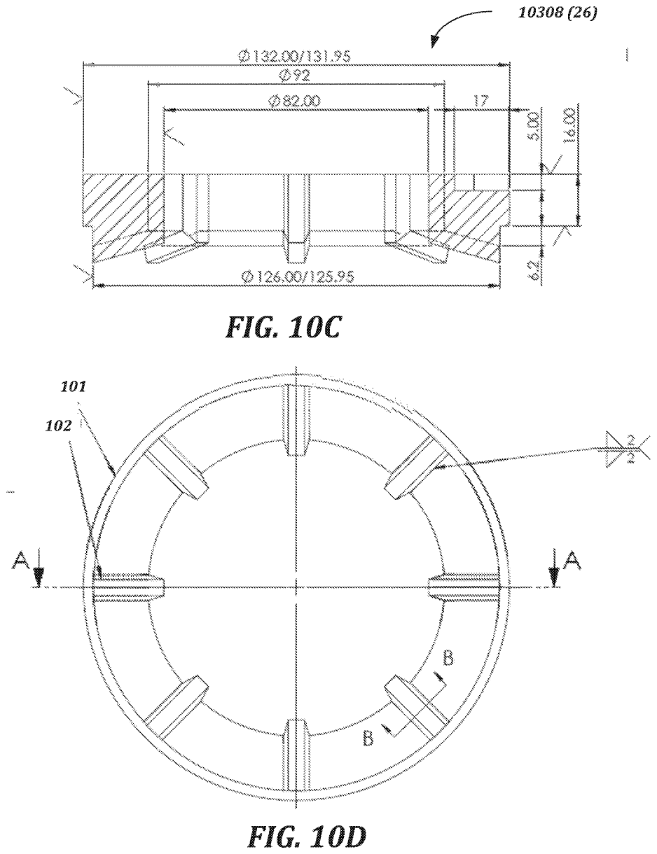

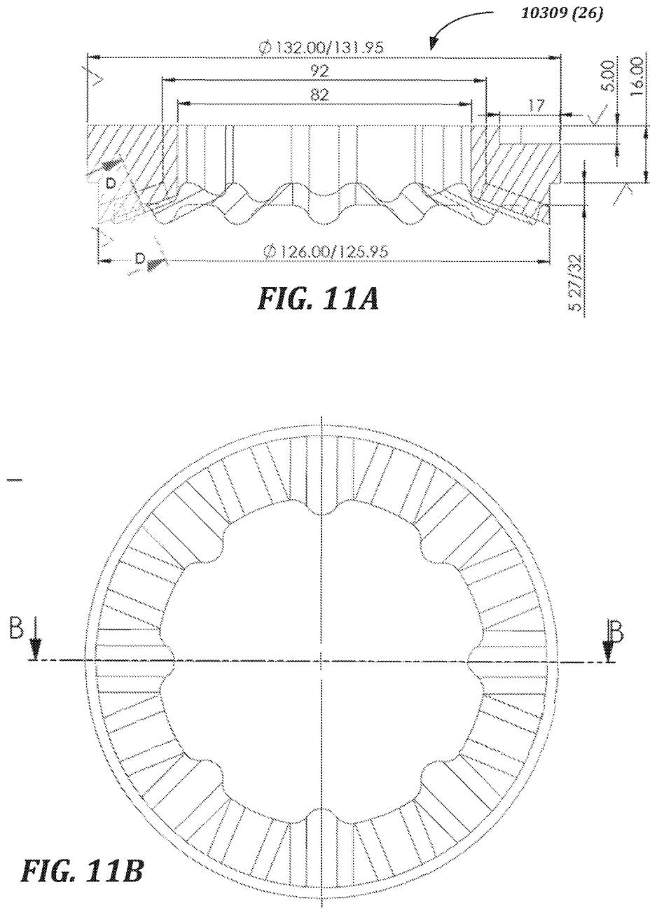

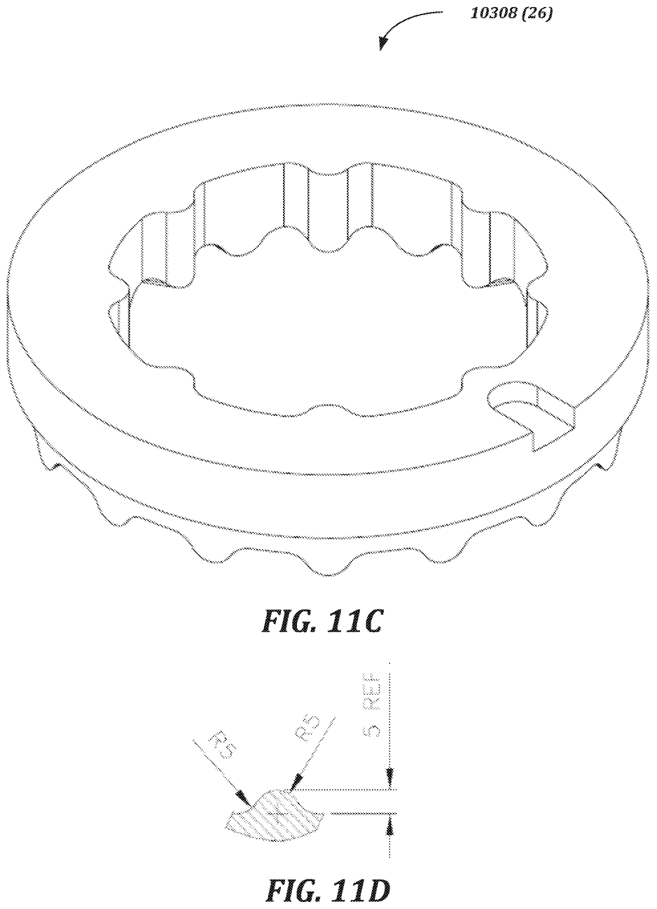

FIGS. 10A-10D shows various view of CONICAL STATOR A01 10308 (26) from mechanical rotating device (C) in accordance with an embodiment of the present invention. FIG. 10A shows an isomeric view thereof, FIG. 10B shows detail view from FIG. 10D, which shows a top view depicting plate portion 101 and eight bar elements 102 on the surface, and FIG. 10C shows a section view A-A from FIG. 10D. FIGS. 11A-11D shows various view of CONICAL STATOR B01 10309 (26) from mechanical rotating device (C) in accordance with another embodiment of the present invention. FIG. 11A shows a section view A-A from FIG. 11B, FIG. 11B shows a top view thereof, FIG. 11C shows an isomeric view thereof, and FIG. 11D section view D-D from FIG. 11A. As shown, this embodiment comprises a sinusoidal surface profile as compared to the plate and bar arrangement from FIG. 10D.

In further aspects, systems in accordance with illustrative embodiments of the present invention, such as system 100 and 300, may also include various other electrical devices such as, for example, heaters, turbines, pumps, measurement devices, internal component temperatures, and other suitable devices. Such electrical device may be linked through any suitable means of transferring electrical signals and/or making electrical connections. In still further aspects, the systems may also include one or more heating sources. In some aspects, the heating source may be in thermal communication with the reaction or process tank to transfer thermal energy from the heating sources to the biomass feedstock and/or process fluid contained within the reaction tank. In other aspects, the heating source may be in thermal communication with the biomass feedstock module to transfer thermal energy from the heating sources to the biomass feedstock prior to entering the reaction tank. The heating source may be any desired source of thermal energy, such as, for example, an electric heater or exhaust gas from a generator as described herein.

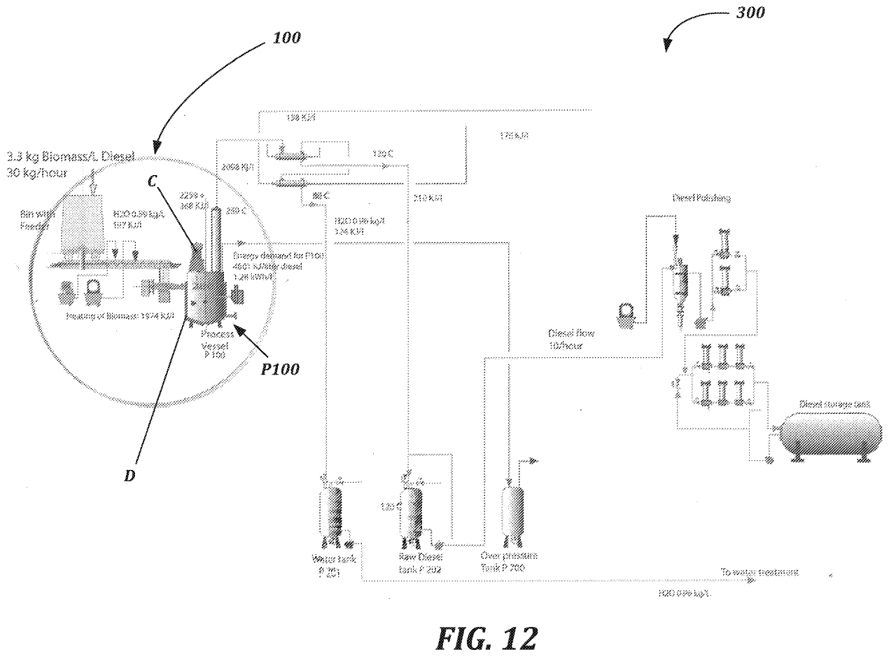

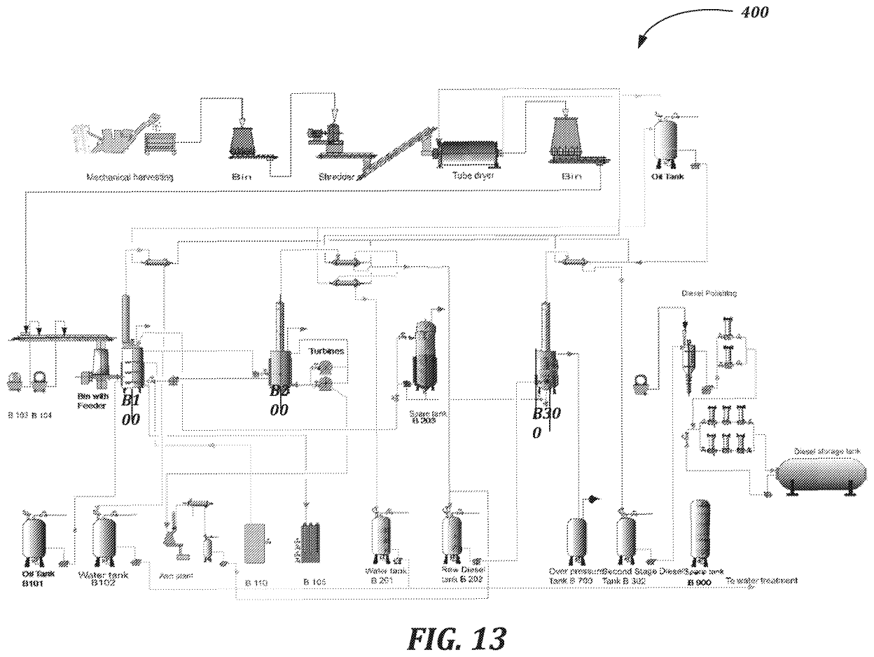

FIG. 12 shows a diagram of a system 300 for converting biomass to biofuel in accordance with another illustrative embodiment of the present invention. FIG. 13 shows prior system 400, which requires pumping oil between different process tanks (i.e., Mixing Vessel B100 and Process Vessel B200) having a 100-degree Celsius differential temperature range, making the temperature control of B200 a bit more problematic and subject to substantial energy and calories loss. In addition, with the turbines installed in a loop outside B200, the temperature of the return oil is dependent of flow and energy applied, which is an additional temperature control challenge and source of energy loss.

In contrast, system 300 configuration employing system 100 with integrated reactor apparatus (P100), which includes mechanical rotating device (C) mounted inside a single process tank (D), can achieve biomass reduction with an internal mixing zone, operating at 280 °C, and provide higher biofuel yields. To this end, at least three process tanks (Mixing Vessel B100, Process Vessel B200, and Secondary Distillation Vessel B300) from system 400 can be replaced with the integrated reactor apparatus P100 of the present invention. Moreover, use of an integrated reactor apparatus in accordance with the present invention can allow reduction of pumps in addition to the number of tanks in a total biomass conversion system.

### D. System Operation and Methods for Use

Also disclosed herein are methods of using the disclosed devices and systems. For example, in another illustrative aspect, the present disclosure provides a method for converting biomass to biofuel using a disclosed apparatus or system.

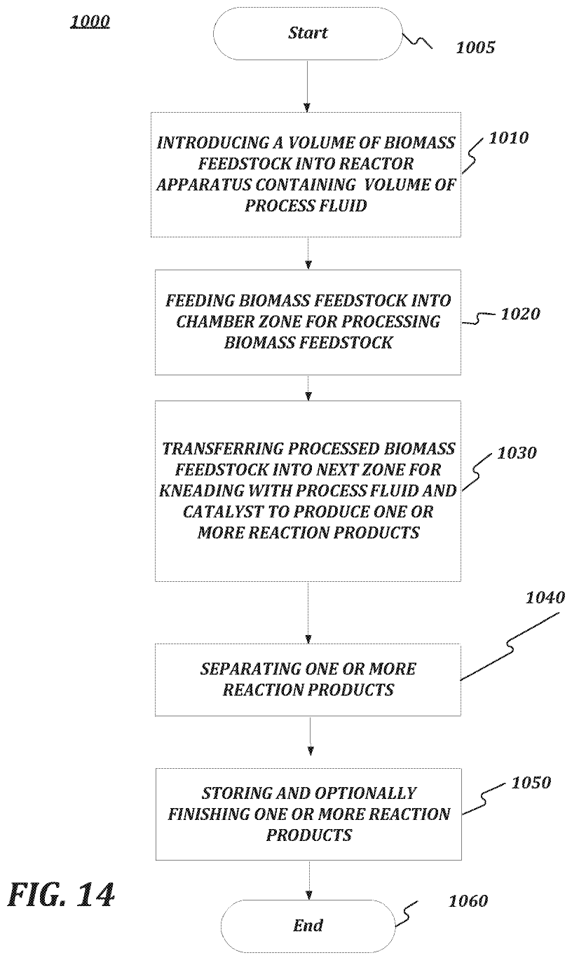

FIG. 14 is a flow chart setting forth the general stages involved in a method 1000 consistent with an embodiment of the disclosure for producing biofuel from biomass using a disclosed reactor apparatus or system. Method 1000 may be implemented using, at least in part, system 100 and system 300. Although stages are disclosed with reference to system 100 and 300, it should be understood that other disclosed embodiments may enable the operation of method 1000, including, but not limited to, other mechanisms, mechanical components, environment properties, user conditions, and the like. Further still, although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

Method 1000 may begin at starting block 1005 and proceed to stage 1010, where a volume of biomass feedstock is introduced into a reactor apparatus containing process fluid. By way of non-limiting example, biomass feedstock may by introduced into heated process oil, lime and catalyst contained in, for example, reaction tank (D) with mechanical rotating device (C). In some aspects, biomass feedstock may be introduced into reactor apparatus using biomass feed bin (A) and biomass feed screw (B). In further aspects, once introduced into reaction tank (D), biomass feedstock may be conveyed or pulled into a first (such as into a feeding section or first processing section) zone having a first rotatable feed screw member arrangement, such as first rotatable feed screw member (9) for receiving, feeding, and/or initially processing biomass feedstock. Biomass feedstock with process fluid may be pulled into or otherwise enter through one or more openings or inlets in the submergible chamber of the mechanical rotating device (C), which contain the various distinct process zones, is submerged in the process fluid, and is configured to operate within process fluid mixture contained in the reaction tank. From stage 1010, where the biomass feedstock has been introduced into first feed zone of reaction apparatus, method 1000 may proceed to stage 1020 where biomass feedstock is fed into a second (which may be a first or second processing zone or the like) distinct zone having a second rotatable feed screw member arrangement, such rotatable cylindrical rotor (11) and cylindrical stator (25), where the biomass feedstock is further processed and size reduced. Process fluid and biomass may enter through four inlet ports at the top of the chamber housing, generally be located in the area around the first section of the mixer/reaction chamber. During operation of mechanical rotating device (C), biomass and process fluid are forced downwards through the various zones, by rotating feed section, the cylindrical the conical section, and internal rotor parts. It should be noted that in some embodiments, first zone may not be present and the biomass feedstock enters directly into second zone for processing.

From stage 1020, where the biomass feedstock has been processed and size reduced, method 1000 may proceed to stage 1030, where the processed biomass feedstock can be transferred into a third distinct zone (such as, for example, a reaction zone) having a third rotatable feed screw member arrangement, such as rotatable conical rotor (14) and/or conical stator (23) for treat the processed biomass feedstock by kneading it with catalyst and heated process oil in reaction tank under conditions effective to convert at least a portion of the processed biomass feedstock to at least one reaction product. In further aspects, stage 1030 takes place in the zone or section of the reaction apparatus having a conical design and configuration, employing a conical rotatable member configured to increase retention time of biomass within this zone. According to further aspects of the invention, an enhance condition generated may include increased retention (e.g., kneading) time of the biomass in device chamber zone through separation of the biomass feed material by density. In this conical section, the biomass material density separation can be higher and retention time is dependent on the production or conversion rate. This step may be continued until all or substantially all the biomass feedstock has been converted into one or more desired reaction product(s), for example, diesel fume, water and CO2. Discharge from the mixer chamber may be through multiple discharge ports, such as the four discharge ports shown at the lower part of the chamber housing area of mechanical rotating device (C).

In some embodiments, the method may be a batch method. In other embodiments, the method may be continuous. During the various stages of the method, the process fluid temperature, pH, and other parameters may be adjusted to ensure method maintains optimal reaction conditions. For example, the process fluid may be heated to within optimal range and lime may be added to adjust the pH to optimal alkaline range. The adjustments may be continuous or batch-wise. One or more reaction byproducts may also be produced, such as silicate, ash, and the like. Depending on the type of biomass used, the percentage of byproduct may be from greater than 0% to less than about 5%, such as about 1, 2, 3, or 4%. To this end, the method may include a cleaning stage or step, where byproducts and/or contamination may be cleaned from the process fluid, continuously or batch wise.

From stage 1030, where the processed biomass feedstock is converted to at least one reaction product, method 1000 may proceed to stage 1040, where the reaction product may be distilled to produce distillate. For example, separation unit (E) with condenser (F) can be used to separate reaction products directly from the reaction tank (D). For example, generated biodiesel fume and water (e.g., steam), may be condensed using two different temperature range condensers, one for diesel and one for water. In further aspects, the CO2, which may be in concentrated phase, can be recovered and vented to other areas for use in other stages and system areas.

From stage 1040, where reaction product(s) has been produced and separated, method 1000 may proceed to stage 1050, where reaction product(s), such as biodiesel fume, may be optionally finished or polished before or after storage through a polishing unit. After stage 1050 where the biofuel is stored, method 1000 may end at stage 1060. In some embodiments, some of the produced biofuel may be directly routed to a generator or other area to be used as fuel for powering the system.

The present invention includes at least the following aspects:
Aspect 01: A system for converting biomass to biofuel, the system comprising: a reaction apparatus comprising: a reaction tank having an inner surface defining an interior space and configured to hold a process fluid; at least one mechanical rotating device comprising: a submergible chamber configured to operate within reaction fluid contained within the reaction tank, the submergible chamber having an inner surface defining an interior space and comprising a plurality of zones including: a zone (or section) including a rotatable member and configured to process biomass feedstock; and a zone (or section) including a rotatable member and configured to treat the processed biomass feedstock effective to convert at least a portion of the processed biomass feedstock to at least one reaction product; a shaft in operable communication with each of the rotatable members for rotating said rotatable members about an axis; and a drive source for driving the shaft about said axis.

Aspect 02: A system for converting biomass to biofuel, the system comprising: a reaction apparatus comprising: a reaction tank having an inner surface defining an interior space and configured to hold a reaction or process fluid; at least one mechanical rotating device comprising: a submergible chamber configured to operate within reaction fluid contained within the reaction tank, the submergible chamber having an inner surface defining an interior space and comprising a plurality of zones including: a first zone (or section) including a first rotatable member and configured to receive biomass feedstock; a second zone (or section) including a second rotatable member and configured to process biomass feedstock from the first feeding zone; and a third reaction zone (or section) including a third rotatable member and configured to treat the processed biomass feedstock effective to convert at least a portion of the processed biomass feedstock to at least one reaction product; a shaft in operable communication with each of the first, second, and third rotatable members for rotating said rotatable members about an axis; and a drive source for driving the shaft about said axis.

Aspect 03: A mechanical rotating system comprising: at least one mechanical rotating device configured to operatively couple with a reaction tank, the at least one mechanical rotating device comprising: a submergible chamber configured to operate within process fluid contained within the reaction tank, the submergible chamber having an inner surface defining an interior space and comprising a plurality of zones including: a zone (or section) including a rotatable member and configured to process biomass feedstock; and a zone (or section) including a rotatable member and configured to treat the processed biomass feedstock effective to convert at least a portion of the processed biomass feedstock to at least one reaction product; a shaft in operable communication with each of the rotatable members for rotating said rotatable members about an axis; and wherein the shaft is configured to be driven about said axis using a drive source.

Aspect 04: The system of any preceding aspect, further comprising a plurality of mechanical rotating devices.

Aspect 05: The system of any preceding aspect, wherein the plurality of zones comprises at least one of: a feeding zone, a processing zone and/or reaction zone, or combinations thereof.

Aspect 06: The system of any preceding aspect, wherein a first zone comprises a first feeding zone (or section) including a first rotatable member and configured to receive biomass feedstock.

Aspect 07: The system of any preceding aspect, wherein the second zone comprises a first processing zone (or section) including a second rotatable member and configured to process biomass feedstock from a first feeding zone.

Aspect 08: The system of any preceding aspect, wherein the third zone comprises a first reaction zone (or section) including a third rotatable member and configured to treat the processed biomass feedstock under conditions effective to convert at least a portion of the processed biomass feedstock to at least one reaction product.

Aspect 09: The system of any preceding aspect, wherein the reaction zone comprises catalyst and lime.

Aspect 10: The system of any preceding aspect, wherein the first zone comprises a feed section configured to receive and feed biomass feedstock to an adjacent zone.

Aspect 11: The system of any preceding aspect, wherein the second zone comprises a size reduction section configured to size reduce biomass feedstock from the first zone.

Aspect 12: The system of any preceding aspect, wherein the third zone comprises a kneading section configured to knead the processed biomass feedstock with catalyst and reaction fluid under conditions effective to convert at least a portion of the processed biomass feedstock to at least one reaction product.

Aspect 13: The system of any preceding aspect, wherein the first zone is in fluid communication with the second zone.

Aspect 14: The system of any preceding aspect, wherein the second zone is in fluid communication with the third zone.

Aspect 15: The system of any preceding aspect, wherein the first feeding zone is in fluid communication with the first processing zone.

Aspect 16: The system of any preceding aspect, wherein the first processing zone is in fluid communication with the first reaction zone.

Aspect 17: The system of any preceding aspect, wherein a rotatable member comprises a feed screw, rotor, or the like.

Aspect 18: The system of any preceding aspect, wherein each rotatable member comprises a surface profile defined by one or more blades, teeth, or fins disposed on an outer surface.

Aspect 19: The system of any preceding aspect, wherein the blade comprises a spiral blade.

Aspect 20: The system of any preceding aspect, wherein the first rotatable member comprises a feed screw configured to move biomass feedstock into the first processing zone.

Aspect 21: The system of any preceding aspect, wherein the second rotatable member comprises a cylindrical rotor configured to process the biomass feedstock.

Aspect 22: The system of any preceding aspect, wherein the third rotatable member comprises a conical rotor configured to facilitate conversion of the processed biomass feedstock into at least one reaction product.

Aspect 23: The system of any preceding aspect, wherein the plurality of zones is in a stacked configuration.

Aspect 24: The system of any preceding aspect, wherein conditions effective to convert at least a portion of the processed biomass feedstock comprise: atmospheric pressure, alkali conditions, process and/or temperature range: 250-350 °C, or combinations thereof.

Aspect 25: The system of any preceding aspect, wherein conditions effective to convert at least a portion of the processed biomass feedstock comprise: a process pressure of about 17 MPa (2465 psig), a biomass conversion time of about 30 minutes, and at a temperature of about 280 degrees Celsius. (536 °F).

Aspect 26: The system of any preceding aspect, wherein conditions effective to convert at least a portion of the processed biomass feedstock comprise a conical helical “lifter” in bottom zone and/or elimination of upper flights to produce a plug flow movement of solid. Aspect 27: The system of any preceding aspect, wherein the drive source comprises a motor, or the like.

Aspect 28: The system of any preceding aspect, wherein the each of the rotatable members are driven by the same drive source.

Aspect 29: The system of any preceding aspect, wherein the reaction product comprises at least one of biofuel, water, char, ash, and/or carbon dioxide, and combinations thereof.

Aspect 30: The system of any preceding aspect, wherein the biomass comprises cellulosic organic material.

Aspect 31: The system of any preceding aspect, wherein the biofuel comprises renewable liquid fuel.

Aspect 32: The system of any preceding aspect, wherein the biofuel comprises renewable liquid fuel in the diesel boiling range.

Aspect 33: The system of any preceding aspect, wherein the renewable liquid fuel comprises diesel fuel.

Aspect 34: The system of any preceding aspect, further comprising a power source.

Aspect 35: The system of any preceding aspect, wherein the power source comprises a generator.

Aspect 36: The system of any preceding aspect, wherein the power source comprises a diesel generator configured to operate using biofuel produced by the system.

Aspect 37: The system of any preceding aspect, further comprising a distillation module.

Aspect 38: The system of any preceding aspect, further comprising a biomass feed module configured to dispense biomass feedstock into the system.

Aspect 39: The system of any preceding aspect, further comprising a biofuel polishing module.

Aspect 40: The system of any preceding aspect, wherein the distillation module comprises a distillation tower, condenser, and/or measuring pipe, or combinations thereof.

Aspect 41: The system of any preceding aspect, wherein the biomass feed module comprises a biomass feed bin, biomass feed screw or conveyor, and/or biomass heater, or combinations thereof.

Aspect 42: The system of any preceding aspect, wherein the at least one mechanical rotating device comprises a surface profile as shown in the figures.

Aspect 43: The system of any preceding aspect, wherein the system is effective to yield a biomass conversion to liquid fuel 20-30% higher than a reference system substantially similar to system 400.

Aspect 44: The system of any preceding aspect, wherein the system is effective to require process energy 30-40% less than a reference system substantially similar to system 400.

Aspect 45: The system of any preceding aspect, wherein the system is effective to control process temperature within the target of +/−1-degree C.

Aspect 46: A method for converting biomass to biofuel, comprising the steps of: a) providing a reaction apparatus or system of any preceding aspect; b) introducing a volume of biomass feedstock into the reaction apparatus or system containing a volume of carrier oil; c) producing a reaction product using the biomass feedstock and process oil; d) distilling the reaction product to produce a distillate; and e) producing biofuel using the distillate.

Aspect 47: The method of any preceding aspect, further comprising introducing at least one catalyst to the carrier oil and biomass feedstock effective to catalyze breakdown at least a portion of the biomass.

Aspect 48: The method of any preceding aspect, wherein the catalyst comprises catalysts of potassium, sodium, calcium, and/or magnesium-aluminum silicates, or combinations thereof.

Aspect 49: The method of any preceding aspect, wherein the catalyst comprises fully crystallized catalysts.

Aspect 50: The method of any preceding aspect, wherein the catalyst is zeolite.

Aspect 51: The method of any preceding aspect, wherein introducing the biomass feedstock comprises introducing the biomass feedstock into a first (feed) zone of the mechanical rotating device.

Aspect 52: The method of any preceding aspect, further comprising feeding the biomass feedstock into a second (processing) zone where biomass feedstock is processed and size reduced.

Aspect 53: The method of any preceding aspect, further comprising transferring biomass feedstock into third (reaction) zone to treat biomass feedstock by kneading it with heated process oil in reaction tank under conditions effective to convert at least a portion of the biomass feedstock to at least one reaction product.

Aspect 54: The method of any preceding aspect, further comprising distilling the reaction product to produce a distillate.

Aspect 55: The method of any preceding aspect, further comprising producing biofuel using the distillate.

Aspect 56: The method of any preceding aspect, wherein the biofuel is liquid diesel.

Aspect 57: The method of any preceding aspect, wherein the method is effective to yield a biomass conversion to liquid fuel 20-30% higher than a reference system substantially similar to system 400.

Aspect 58: The method of any preceding aspect, wherein the method is effective to require process energy 30-40% less than a reference system substantially similar to system 400.

Aspect 59: The method of any preceding aspect, wherein the method is effective to control process temperature within the target of +/−1-degree C.

### E. System Configuration—Alternative Embodiment

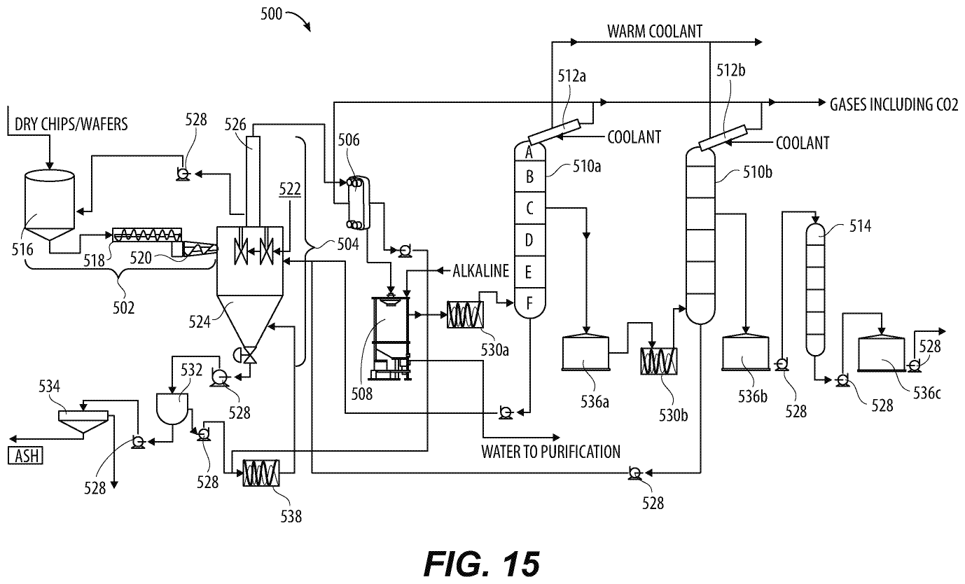

Referring now to FIG. 15, a further embodiment of the present disclosure is illustrated in which a system 500 is configured to convert biomass to biofuel. The system 500 comprises a biomass feed module 502, a reaction apparatus 504, a condenser 506, a separation tank 508, a plurality of distillation columns 510a and 510b (collectively, distillation columns 510) each including a reflux system 512a and 512b, respectively, and a purifying column 514. It is contemplated within the scope of the present disclosure that system 500 for conversion of biomass to biofuel preferably utilizes thin dry wood chips or wafers to convert biomass to biofuel, as will be discussed in more detail below.

In the embodiment of FIG. 15, the biomass feed module 502 comprises a chip bin 516, a conveyor 518, and a plug screw feeder 520. It will be understood that the chip bin 516 and the plug screw feeder 520 may be substantially similar and correspond in structure and/or function to the biomass feed bin (A) and the biomass feed screw (B) described above, respectively. The reaction apparatus 504 includes one or more mixers 522 being integrated therein, a reaction vessel 524, and an insulated venting tower 526 being fluidly coupled with the reaction vessel 524 and extending therefrom. It will be understood that the one or more mixers 522 and reaction vessel 524 may be substantially similar and correspond in structure and/or function to the mechanical rotating device (C) and reaction tank (D) of system 100 described above, respectively. It will be appreciated that, in some embodiments, the integrated reactor apparatus (P100) of system 300, described above, may be used as the reaction apparatus 504 of system 500.

It should be noted that, in some embodiments, the system 500 may include one or more condensers 506. Each condenser 506 may be substantially similar to, and may correspond in structure and/or function with, the condenser (F) of system 100 described above. The insulated venting tower 526 is configured to permit volatile compounds to exit the reaction apparatus 504. If the venting tower 526 is insufficiently insulated, the vapor temperature proximate an upper region of the venting tower 526 may be reduced to an undesirably low level, thereby causing a significant portion of the vented material to condense within the venting tower 526. Such condensation can reduce the removal efficiency of volatile components from the reaction apparatus 504 and can impede passage of the vented material through the venting tower 526 and into the condenser 506. Depending on the configuration of the condenser 506 and the temperature drop across the condenser 506, relatively high-boiling compounds may be condensed and at least partially separated, and may be returned to the reaction apparatus 504 for further cracking to produce lower-molecular-weight compounds within a diesel-range fraction.

In the present embodiment, each of the distillation columns 510 is configured as a vertical, industrial-scale distillation column including a plurality of horizontal bubble cap trays (not shown), which function as equilibrium stages for separating liquid mixtures based on differences in volatility. It is within the scope of the present disclosure that the dimensions, including the length, of each distillation column 510 may be selected or varied to optimize separation performance and achieve a desired product yield. Each reflux system 512a, 512b is fluidly coupled to a corresponding distillation column 510a, 510b and is configured to enhance separation efficiency and product purity by condensing vapor rising through the respective column 510a, 510b into a liquid and dividing the liquid into a distillate portion and a reflux portion, the reflux portion being returned to the column. Each of the reflux systems 512a, 512b may be implemented as a shell-and-tube condenser, wherein a coolant, such as cooling water, flows through one or more tubes to facilitate condensation of vapor on the shell side, thereby enabling the resulting condensate to return to the corresponding distillation column 510a, 510b. In the present embodiment two columns 510a, 510b are illustrated, however depending on the quality of the diesel to be manufactured one column may suffice.

In some embodiments, as can be seen in FIG. 15, the purifying column 514 may be installed downstream of the distillation columns 510 to achieve final product quality specifications. It is envisioned that, in some embodiments, the purifying column 514 may be filled with bentonite and/or clay or other material capable of cleaning and purifying diesel or biodiesel. The purifying column 514 is configured to operate at tighter operating conditions to remove trace impurities, such as closely boiling contaminants or by-products, micro sized solid particles, residual solvents, or dissolved gases that remained in the intermediate stream after the distillation columns 510 have removed most light and heavy molecular weight components. The system 500, as will be discussed below, further includes a plurality of vacuum pumps 528, a plurality of heaters 530a and 530b, a settling tank 532, a centrifuge 534, and regeneration furnace 538, and a plurality of biodiesel storage tanks 536a-536c (collectively, storage tanks 536).

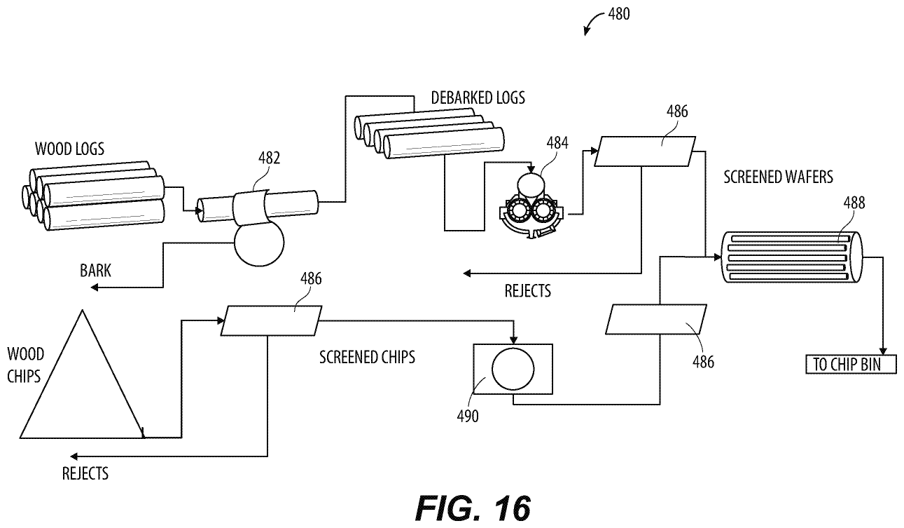

Referring now to FIG. 16, an embodiment of a feedstock preparation system 480 is illustrated. The feedstock preparation system 480 is configured to receive lignocellulosic feedstock and to condition the feedstock to a selected geometry (e.g., thickness and/or size distribution) and moisture content suitable for downstream processing in system 500. In some embodiments, the feedstock preparation system 480 is configured to accept incoming feedstock in multiple forms and to route the feedstock to different preparation pathways based on the form of the incoming feedstock. For example, the feedstock may comprise hardwood and/or softwood sourced as round wood, chips, and/or shavings. In some embodiments, hardwood may be preferred for subsequent processing in system 500 due to its open cell/vessel structure, faster reaction time, and reduced coking risk. Although the exemplary embodiments described herein refer to hardwood and/or softwood, other lignocellulosic feedstocks may likewise be used, including forestry residues (e.g., wood-processing residues) and agricultural residues (e.g., corn stover, wheat and/or rice straw, and sugarcane bagasse), among others.

In embodiments in which the feedstock is received as round wood, system 480 routes the round wood to a round wood preparation subsystem configured to convert the round wood into wafers and/or shavings. In embodiments in which the feedstock is received as chips, system 480 routes the chips to a chip preparation subsystem configured to generate shavings. The round wood preparation subsystem comprises a debarking unit 482, a wood chipper or waferizer 484, one or more screening devices (e.g., screen 486), and a rotary tube dryer or flake dryer 488. The chip preparation subsystem comprises a flaker or splicer 490, one or more screening devices (e.g., one or more of the screens 486), and the rotary tube dryer or flake dryer 488, which in some embodiments is shared between the subsystems.

When the feedstock is received as round wood (e.g., logs), the system 480 routes the round wood through the debarking unit 482 to remove bark. In some embodiments, bark removed from the round wood is reclaimed and diverted for beneficial use, including energy generation and/or use in a pulp mill to generate electricity and/or steam. The debarked wood is processed by the waferizer 484 to form thin wafers and/or shavings, which in some embodiments have a thickness of about 0.1-0.3 mm for softwood and up to about 0.5 mm for hardwood. The wafers and/or shavings are screened via the screen 486 to remove overs and knots and are then dried in the rotary tube dryer 488 to a moisture content of about 10%, thereby reducing energy loss and mitigating yield loss during subsequent processing in the system 500. In some embodiments, drying softwood below about 8% moisture content may result in irreversible hornification, a cell wall sealing effect that inhibits catalyst penetration and is therefore undesirable.

In embodiments in which the feedstock is received as chips, the system 480 may screen the chips via the screen 486 prior to size reduction. The chips are then processed by the splicer 490 to generate shavings having, in some embodiments, a thickness of about 0.1-0.3 mm for softwood and up to about 0.5 mm for hardwood. In some embodiments, the shavings are screened (e.g., via the screen 486) to remove overs and knots and are then dried in the rotary tube dryer 488 until reaching a moisture content of about 10%, thereby minimizing energy loss and maintaining yield during subsequent processing in the system 500. In some embodiments, drying softwood below about 8% moisture content may result in irreversible hornification, a form of cell wall sealing that inhibits catalyst penetration. It will be appreciated that the dried wood wafers and/or shavings produced via the preparation pathways described above are subsequently conveyed to, and received within, the chip bin 516 of the biomass feed module 502 of system 500.

### F. System Operation and Methods—Alternative Embodiment

As discussed above, and with reference to the embodiment of system 500, the system 500 is configured to receive a prepared and dried lignocellulosic biomass feedstock and convert the biomass into one or more biofuel products. In operation, system 500 receives a dried biomass feedstock (e.g., wood wafers and/or shavings) and introduces the feedstock into a reaction environment in which the biomass is contacted with a catalyst and a high-boiling-point carrier oil under controlled thermal and pressure conditions to promote conversion of the biomass into lower-molecular-weight hydrocarbon products.

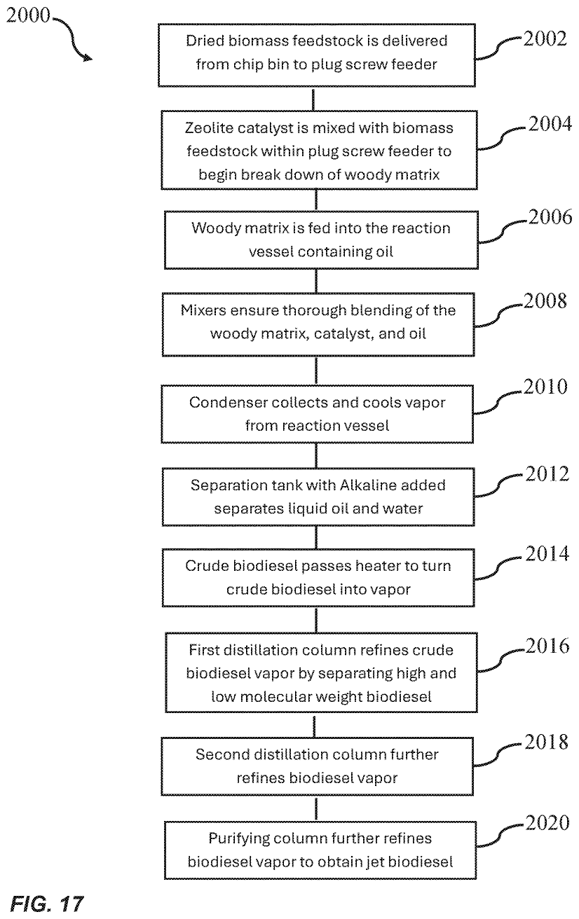

As shown in FIG. 15, the dried biomass feedstock is stored in, or otherwise delivered to, the chip bin 516. The chip bin 516 may be configured to act as a supply reservoir that provides a substantially continuous or batchwise source of dried feedstock to downstream feeding equipment. With reference now to FIG. 17, which is a flow chart setting forth the general stages involved in a method 2000 consistent with an embodiment of the disclosure for producing biofuel from dried biomass feedstock, at step 2002, the dried biomass feedstock is delivered from the chip bin 516, via the conveyor 518 that transports the feedstock, toward the plug screw feeder 520. The conveyor 518 may be configured to provide a controlled feed rate of the dried biomass feedstock to the plug screw feeder 520 by maintaining desired throughput and stable downstream operating conditions. The plug screw feeder 520 is configured to receive the dried biomass feedstock from the conveyor 518 and provide mechanical conveyance of the feedstock toward the reaction vessel 524.

In certain embodiments, the plug screw feeder 520 may provide a sealing function that reduces the ingress of ambient air into downstream equipment and/or assists in maintaining a reduced pressure condition within the reaction apparatus 504. At step 2004, a catalyst is introduced to the dried biomass feedstock at or near an inlet region of the plug screw feeder 520. For example, a zeolite catalyst (e.g., Zeolite 3A or a variation thereof) may be mixed with the biomass as the dried biomass feedstock enters the plug screw feeder 520. In some embodiments, the catalyst is combined with the biomass feedstock within the plug screw feeder 520 such that initial catalyst-biomass contact occurs prior to introduction of the biomass into a reaction vessel 524. It will be understood that the catalyst assists in initiating breakdown of a “woody matrix” of the biomass feedstock. As used herein, the “woody matrix” may refer to a wood mixture comprised of lignin, cellulose, and hemicellulose, which collectively form the structural plant material of lignocellulosic biomass. In some embodiments, catalyst contact begins in the plug screw feeder 520 and continues downstream, thereby promoting rapid breakdown of the woody matrix into shorter hydrocarbon chains and other biomass-derived intermediates and/or reaction products.

It should be appreciated that the conversion behavior of different components of the woody matrix may differ. For example, hemicelluloses may break down relatively rapidly, followed by lignin (C30-C10 molecules), which is believed to represent a primary source of biofuel (e.g., biodiesel-range) yield, and cellulose may be among the later components to crack or depolymerize under reaction conditions. At step 2006, the biomass feedstock and catalyst mixture (i.e., the woody matrix combined with zeolite catalyst) is delivered from the plug screw feeder 520 into the reaction vessel 524. The reaction vessel 524 may be pre-filled with a high-boiling-point carrier oil (e.g., initially at approximately room temperature), the carrier oil being selected to tolerate elevated operating temperatures, for example up to about 350 °C. In operation, the reaction vessel 524 is maintained at an elevated reaction temperature, such as about 280-290°C, and under a reduced pressure condition (e.g., a slight vacuum) provided by vacuum 528 to facilitate removal of excess air and/or volatile materials and to provide a controlled reaction environment.

At step 2008, the one or more mixers 522 agitate contents of the reaction vessel 524 to promote thorough blending of the biomass feedstock, the catalyst (e.g., zeolite catalyst), and the carrier oil. Such mixing, as provided by the one or more mixers 522, improves heat transfer, maintains a more uniform temperature within the reaction vessel 524, and enhances catalyst contact/chemical penetration with lignin, cellulose, and hemicellulose components of the biomass to support progressive conversion of the woody matrix into biomass-derived reaction products.

In some embodiments, during catalytic conversion in the reaction vessel 524, at least a portion of the carbohydrate fraction of the biomass—the portion of the biomass made up of carbohydrate polymers, primarily cellulose and hemicellulose—is converted to CO₂ and water, while the remainder of the carbohydrate fraction (i.e., carbohydrates other than lignin) forms a furan-type biodiesel component/material (e.g., a lower-molecular-weight biodiesel fraction), and lignin is converted to a higher-molecular-weight biodiesel fraction. The reaction vessel 524 thereby produces a reaction mixture that includes: (i) liquid-phase carrier oil containing dissolved and/or suspended biomass-derived products; (ii) biofuel-range components derived from lignin and/or carbohydrate conversion; and (iii) gaseous by-products including CO₂ and other volatile or non-condensable gases generated during conversion. In some embodiments, vapors (including biodiesel vapor, water, CO₂, and non-condensable gases) exit the reaction vessel under vacuum for downstream condensation and separation, as will be discussed below.

In some embodiments, the reaction vessel 524 of the reaction apparatus 504 operates under a reduced pressure condition (e.g., a slight vacuum) to facilitate removal of volatile materials and to withdraw a vapor stream that may include one or more condensable biofuel components and water vapor, as well as non-condensable gases. For example, in some embodiments, vapors including biodiesel, water, CO₂, and non-condensable gases are withdrawn from the reaction vessel under vacuum for downstream recovery. After purification of this gas stream to mainly CO₂, as shown in FIG. 15, it is contemplated that the removed CO₂ is collected as part of a gas stream and may be routed to downstream gas handling equipment (e.g., capture, purification, measurement, or venting).

It is also envisioned that, during continued operation of system 500, a small quantity of residual solids may accumulate within the reaction vessel 524, including unconverted/not fully broken-down woody material, inorganic ash originating from the biomass feedstock, and spent or deactivated catalyst (e.g., spent zeolite). To maintain operability of the reaction vessel 524 and reduce coking, fouling, and system plugging, the system 500 is configured to remove such solids from the reaction vessel 524 on a continuous or semi-continuous basis into the settling tank 532 configured to receive sludge in the form of ash and spent catalyst. From the settling tank 532, system 500 is configured to route the sludge to the centrifuge 534 configured to segregate an ash fraction from a catalyst-containing fraction, with the catalyst-containing fraction, depending on its activity level, optionally recovered and recycled back to the reaction vessel 524, as shown in FIG. 15. In some embodiments, the recovered catalyst is routed to a regeneration furnace (a “catalyst cleaner”) 538 that burns off coke deposits and returns regenerated catalyst to the reaction vessel 524 for reuse.

At step 2010, the vapor stream withdrawn from the reaction vessel 524 is routed, via the insulated venting tower 526, which may cool the vapor stream by a few degrees, to the condenser 506. The condenser 506 may contain a cooling oil, such as carrier oil at room temperature, and may comprise a heat exchanger (not shown), such as a plate heat exchanger, configured to cool the vapor stream and thereby condense at least a portion of the condensable components to form a liquid phase. For example, it is contemplated that the condenser 506, which may include an AlfaNova plate heat exchanger, is configured to collect and cool the vapor stream, converting at least a portion of the vapor stream into a liquid oil (biodiesel) mixed with some water generated in the conversion reaction. It is further contemplated, as shown in FIG. 15, that non-condensable gases (including CO₂ and other gases) are separated and pass through for downstream gas handling.

At step 2012, the condensed liquid stream (e.g., liquid oil/H₂O mixture) proceeds from the condenser 506 to the separation tank 508. The separation tank 508 may be configured to separate an oil phase (e.g., crude biodiesel) from an aqueous phase (e.g., water produced during biomass conversion and/or condensed moisture). The separation tank 508 is envisioned to operate at an elevated temperature to promote phase disengagement and reduce viscosity of the oil phase. For example, the separation tank 508 may be controlled at about 100 °C to facilitate separation of oil (liquid biodiesel) from water. It is further envisioned that an alkaline material is added to the separation tank 508 to adjust acidity of the mixture. As a non-limiting example, the alkaline material may include lime, magnesium oxide, sodium hydroxide, or potassium hydroxide. For example, the alkaline material may be introduced to raise the pH of the oil/H₂O mixture from about pH 4 to about pH 7. As shown in FIG. 15, the aqueous phase separated in the separation tank 508 is routed to a downstream water handling operation (e.g., “water to purification”) while the oil phase (crude biodiesel) is routed to downstream heating and distillation for refinement.

At step 2014, crude biodiesel withdrawn from the separation tank 508 is heated prior to distillation. For example, the crude biodiesel may be passed through the heater 530a (FIG. 15) configured to raise the temperature of the crude biodiesel to about 150-180 °C to form a vapor stream suitable for introduction into a distillation unit. In such embodiments, heating converts at least a portion of the crude biodiesel into a biofuel vapor that is subsequently introduced into the distillation column 510a.

The distillation column 510a is configured to separate component mixtures according to differences in boiling point. Components having relatively lower boiling points and lower molecular weights preferentially migrate toward an upper region of the column and may be withdrawn as an overhead fraction, while components having relatively higher boiling points and higher molecular weights preferentially remain in lower regions of the column and may be withdrawn as a bottoms fraction. At step 2016, heated crude biodiesel vapor is introduced into the distillation column 510a, which is configured to refine the crude biodiesel vapor by separating higher-boiling components (e.g., higher-molecular-weight fraction) from lower-boiling components (e.g., lower-molecular-weight fraction). In this manner, a mid-range biodiesel fraction having a target distribution of intermediate molecular-weight compounds is produced and withdrawn for subsequent processing and refinement.

By way of example, with reference to the distillation column 510a illustrated in FIG. 15, lower-molecular-weight fractions, such as naphtha-range or gasoline-range components, are configured to rise into upper sections A and B of the vertical column 510a and to be further processed via the reflux system 512a, wherein a distillate portion exits the system and a reflux portion is returned to the column to assist separation. Higher-molecular-weight fractions, such as heavy diesel-range components, are configured to rise into lower sections E and F of the vertical column 510a, while intermediate fractions, including jet-range or mid-range biodiesel components, rise, condense, and are withdrawn from intermediate sections C and D of the column 510a. The bottom fraction comprising high-molecular-weight components (e.g., C60+) may be withdrawn from the distillation column 510a and routed back to the reaction vessel 524 for reuse, while the desired distribution of mid-range biodiesel fraction or refined product stream is routed and stored in the storage tank 536a.

In a preferred embodiment, shown in FIG. 15, system 500 includes at least two distillation columns 510a, 510b arranged in series. In such embodiment, the distillation column 510a performs a primary fractionation (e.g., removing heavier fractions and stabilizing a desired biodiesel distribution), while the distillation column 510b performs further fractionation and purification of the refined product stream at tighter operating parameters to produce a cleaner biodiesel product stream or further refined product stream. For example, the distillation column 510b may be configured to narrow the boiling range of the refined product stream and/or reduce components outside a desired specification by withdrawing additional overhead and/or bottom fractions. To accomplish such further fractionation and purification, the refined product stream is routed from the storage tank 536a through the heater 536b configured to raise the temperature of the refined product stream to about 150-180 °C to form a vapor stream suitable for introduction into the distillation column 510b such that, at step 2018, the distillation column 510b can perform further fractionation and purification of the refined product stream to produce a cleaner biodiesel or further refined product stream that can be stored in the storage tank 536b.

As illustrated in FIG. 15 and shown in FIG. 17, the further refined product stream can be further purified into a jet-range biodiesel by being even further distilled through the purification column 514 in the similar manner described in detail above. The jet-range biodiesel received from the purification column 514 can be stored in the storage tank 536c.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entirety are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method for converting biomass to biofuel, the method comprising:
introducing a biomass feedstock to a reaction apparatus, the reaction apparatus comprising:
a reaction vessel configured to contain a reaction fluid; and
at least one mechanical rotating device comprising:
a chamber configured to operate within the reaction fluid, the chamber having an inner surface defining an interior cavity and comprising a plurality of zones including:
a first zone having a first rotatable member and configured to receive and convey the biomass feedstock along the interior cavity;
a second zone having a second rotatable member and configured to process the biomass feedstock received from the first zone; and
a third zone having a third rotatable member and configured to treat the processed biomass feedstock to convert at least a portion of the processed biomass feedstock to a vapor-phase reaction product;
a shaft coupled to the rotatable members and configured to rotate the rotatable members about an axis; and
a drive source for driving the shaft about the axis;
withdrawing the vapor-phase reaction product from the reaction vessel for downstream processing;
condensing the vapor-phase reaction product to form a liquid mixture comprising a liquid oil and an aqueous solution;
separating the liquid oil from the aqueous solution; and
vaporizing and distilling the liquid oil to produce a selected biofuel fraction.

2. The method of claim 1, wherein the first rotatable member comprises a feed screw configured to convey the biomass feedstock into the second zone, wherein the second rotatable member comprises a cylindrical rotor configured to process the biomass feedstock, and wherein the third rotatable member comprises a conical rotor configured to facilitate conversion of the processed biomass feedstock into the vapor-phase reaction product.

3. The method of claim 1, wherein the reaction apparatus further comprises a venting tower being insulated and in fluid communication with the reaction vessel, and wherein the step of withdrawing the vapor-phase reaction product includes directing the vapor-phase reaction product to flow from the reaction vessel through the venting tower to the condenser.

4. The method of claim 1, wherein the step of introducing a biomass feedstock to a reaction apparatus comprises:
receiving a dried biomass feedstock by a feeder;
adding a catalyst and mixing the catalyst with the dried biomass feedstock within the feeder to form a feedstock mixture; and
conveying the feedstock mixture to the reaction vessel.

5. The method of claim 4, wherein the reaction fluid comprises a high-boiling-point carrier oil, and wherein the feedstock mixture, in operation, is brought into contact with the carrier oil within the reaction vessel under predetermined temperature and pressure conditions.

6. The method of claim 5, wherein the at least one mechanical rotating device is configured to agitate the feedstock mixture and carrier oil within the reaction vessel to support conversion of the processed biomass feedstock into the vapor-phase reaction product.

7. The method of claim 1, wherein the step of condensing the vapor-phase reaction product comprises controlling a temperature of a condenser to selectively condense components of the vapor-phase reaction product based on volatility to form the liquid mixture comprising the liquid oil and the aqueous solution.

8. The method of claim 7, wherein the step of separating the liquid oil from the aqueous solution comprises:
maintaining a temperature within a separation unit sufficient to reduce viscosity and facilitate separation of the liquid oil and the aqueous solution; and
adding an alkaline material to increase a pH of the liquid mixture and promote separation of the liquid oil from the aqueous solution.

9. The method of claim 8, wherein the step of vaporizing comprises:
withdrawing the liquid oil from the separation unit; and
heating the liquid oil using a heating unit to a temperature of 150-180 °C to vaporize at least a portion of the liquid oil and form a vapor stream for feeding to a distillation unit.

10. The method of claim 9, wherein the step of distilling the liquid oil comprises:
receiving, by a first distillation unit, the vapor stream from the heating unit; and
distilling the vapor stream within the first distillation unit to separate the vapor stream into a first higher-boiling fraction, a first mid-boiling fraction, and a first lower-boiling fraction, the first mid-boiling fraction forming the selected biofuel fraction.

11. The method of claim 10, wherein the step of distilling further comprises:
receiving, by a second distillation unit, the selected biofuel fraction, the second distillation unit configured to operate under narrower temperature or pressure ranges than the first distillation unit; and
distilling the selected biofuel fraction within the second distillation unit to separate the selected biofuel fraction into a second higher-boiling fraction, a second mid-boiling fraction, and a second lower-boiling fraction, the second mid-boiling fraction forming a refined biofuel fraction.

12. The method of claim 11, wherein the step of distilling further comprises:
receiving, by a purification unit, the refined biofuel fraction, the purification unit configured to operate under narrower temperature or pressure ranges than the second distillation unit; and
distilling the refined biofuel fraction within the purification unit to separate the refined biofuel fraction into a third higher-boiling fraction, a third mid-boiling fraction, and a third lower-boiling fraction, the third mid-boiling fraction forming a jet-range biofuel fraction.

13. A system for converting a biomass feedstock to biofuel, the system comprising:
a reaction apparatus including a reaction vessel configured to contain a reaction fluid, an insulated venting tower fluidly coupled with the reaction vessel and extending therefrom, and a mechanical rotating device, wherein the mechanical rotating device comprises:
a chamber configured to operate within the reaction fluid, the chamber having an inner surface defining an interior cavity and comprising a plurality of zones including:
a first zone having a first rotatable member and configured to receive and convey the biomass feedstock along the interior cavity;
a second zone having a second rotatable member and configured to process the biomass feedstock received from the first zone; and
a third zone having a third rotatable member and configured to treat the processed biomass feedstock to convert at least a portion of the processed biomass feedstock to a vapor-phase reaction product;
a shaft coupled to the rotatable members and configured to rotate the rotatable members about an axis; and
a drive source for driving the shaft about the axis.

14. The system of claim 13, wherein the first rotatable member comprises a feed screw configured to convey the biomass feedstock into the second zone, wherein the second rotatable member comprises a cylindrical rotor configured to process the biomass feedstock, and wherein the third rotatable member comprises a conical rotor configured to facilitate conversion of the processed biomass feedstock into the vapor-phase reaction product.

15. The system of claim 13, wherein the reaction fluid comprises a high-boiling-point carrier oil, and wherein the mechanical rotating device is configured to agitate the biomass feedstock, a catalyst, and the carrier oil within the reaction vessel to support conversion of the processed biomass feedstock into the vapor-phase reaction product.

16. The system of claim 13, further comprising:
a condenser configured to cool the vapor-phase reaction product to selectively condense at least a portion of the vapor-phase reaction product to form a liquid mixture comprising a liquid oil and an aqueous solution, the condenser containing a cooling oil and including a heat exchanger.

17. The system of claim 16, further comprising:
a separation tank configured to be operated at an elevated temperature to facilitate separation of the liquid oil and the aqueous solution; and
a plurality of heating units capable of heating the liquid oil to a temperature in the range of 150-180 °C to form a vapor stream.

18. The system of claim 17, further comprising one or more distillation columns configured to distill the vapor stream within the one or more distillation columns by separating the vapor stream into a higher-boiling fraction, a mid-boiling fraction, and a lower-boiling fraction.

19. The system of claim 18, further comprising one or more storage tanks configured to store the mid-boiling fraction withdrawn from respective one of the one or more distillation columns.

20. The system of claim 19, further comprising a purification column configured to operate under narrower temperature or pressure ranges than the one or more distillation columns and further refine the mid-boiling fraction to form a jet-range biofuel fraction.
